(19) United States
(12) Patent Application Publication
(10) Pub. No.: US 2025/0314617 A1
(43) Pub. Date: Oct. 9, 2025

(54) MEASUREMENT DEVICE AND MEASUREMENT METHOD

(71) Applicant: JAPAN SCIENCE AND TECHNOLOGY AGENCY, Saitama (JP)

(72) Inventors: Kenji IKUSHIMA, Tokyo (JP); Yamato ANZAI, Tokyo (JP); Yuki SAKAKURA, Tokyo (JP)

(21) Appl. No.: 18/863,049

(22) PCT Filed: Feb. 21, 2023
(86) PCT No.: PCT/JP2023/006283

§ 371 Date: Nov. 5, 2024

(30) Foreign Application Priority Data
May 13, 2022 (JP) 2022-079646

(51) Int. Cl. G01N 27/72

(52) U.S. Cl. CPC G01N 27/725

(57) ABSTRACT

One measurement device 100 of the present invention comprises: a sound-wave transmission unit 120 that transmits sound waves to a measurement object 10; detection units 130A, 130B that detect electro-magnetic fields which are generated by the measurement object 10 as a result of the sound waves having been emitted from the sound-wave transmission unit, the electro-magnetic fields being from a plurality of mutually different directions or in a plurality of mutually different locations; and an evaluation unit 152 that evaluates characteristics pertaining to the anisotropy of the measurement object 10, on the basis of the results of detection of the electro-magnetic fields by the detection units 130A, 130B.

### TECHNICAL FIELD

This disclosure relates to a measurement device and a measurement method.

### BACKGROUND ART

When measuring electrical, magnetic or other characteristics of an object, it is usually better to use electromagnetic fields of light or radio waves. However, it is difficult to measure characteristics using light on objects such as human bodies, metals, or concrete blocks, which are difficult for light to penetrate. Therefore, while taking advantage of the characteristics of sound waves, which have high internal permeability to objects such as the human bodies metals or concrete blocks, which are difficult for light to penetrate, and a wavelength that is about five orders of magnitude shorter than that of electromagnetic fields of the same frequency, and thus have higher spatial resolution in the depth and in-plane direction of the object compared to radio wave measurements of the same frequency, a device and a method for measuring object characteristics using acoustically induced electromagnetic fields that can be used to measure objects are disclosed.

Patent Literature 1 discloses a technique for irradiating an object to be measured with ultrasonic waves, measuring the electromagnetic fields generated by the object to be measured, and measuring any of the electrical, magnetic or electromagnetic/mechanical characteristics of the object to be measured from any of the intensity, phase and frequency characteristics of the electromagnetic fields or a combination thereof. In addition, Patent Literature 2 discloses a technique for detecting an electromagnetic fields generated by an amplitude-modulated sound wave irradiating an object to be measured, and for extracting an electrical characteristic, a magnetic characteristic, an electromechanical characteristic and a magnetomechanical characteristic of the object to be measured based on at least one measurement selected from the group consisting of the intensity, phase and frequency characteristics of the electromagnetic fields. This method of measuring the electromagnetic response excited by ultrasonic waves is called the Acoustically Stimulated Electro Magnetic (ASEM) method.

### RELATED-ART LITERATURE

### Patent Literature

Patent Literature 1: Japanese Patent No. 4919967
Patent Literature 2: Japanese Patent No. 5892623

### Non Patent Literature

Non Patent Literature 1: Beaurepaire and 5 others, Appl. Phys. Lett. Vol. 84, No. 18, pp. 3465-3467, 3. May 2004

### SUMMARY OF INVENTION

### Technical Problem

It is an object of this invention to provide a measurement device and a measurement method that can quantitatively or qualitatively evaluate the crystallinity or orientation of a tissue having an anisotropic structure such as a crystal without a center of symmetry or a fiber structure using an acoustically induced electromagnetic method.

### Solution to Problem

When measuring the electromagnetic fields generated by an object to be measured using the ASEM method, the inventor has found that, for example, when the object to be measured is a crystal without a center of symmetry or a tissue with an anisotropic structure such as a fiber structure, electric polarization, or piezoelectric polarization, is induced in the object to be measured by the sound waves, e.g., ultrasound, irradiated to it. The results show that the sound waves, e.g., ultrasound, induce electrical polarization, or piezoelectric polarization, in the object to be measured. Having learned that the anisotropy of the polarization greatly affects the anisotropy of the object to be measured and the crystallinity or orientation of the object to be measured, the inventor has made diligent research and analysis to accurately evaluate the characteristics of the anisotropy, e.g., direction of polarization, magnitude of polarization, degree of anisotropy of polarization, and from these polarization anisotropies, the crystal direction, degree of crystallinity and orientation of the object to be measured.

As a result, it was found that the anisotropy can be evaluated with a high degree of accuracy by devising the number, arrangement and/or detection method of the detector that detects the electromagnetic field signals from the object to be measured, depending on the characteristics of the object to be measured. In addition, in the course of the aforementioned innovations, the inventor has also created a measurement device and a measurement method that can accurately reduce or eliminate noise that inevitably exists at the time when the detector detects the electromagnetic fields to be measured. The present invention was created based on the above findings.

One measurement device of the present invention comprises a sound wave transmitter transmitting sound waves to an object to be measured, a detector detecting electromagnetic fields from multiple directions that differ from each other or at multiple locations that differ from each other, generated by the object to be measured due to the sound waves emitted from the sound wave transmitter and an evaluator evaluating anisotropic characteristics of the object to be measured based on the detection results of the electromagnetic fields detected by the detector.

According to this measuring device, when detecting the electromagnetic fields from the object to be measured generated by the sound wave irradiation described above, the detector can detect the electromagnetic fields from multiple directions that differ from each other or at multiple locations that differ from each other. Therefore, it is possible to evaluate the anisotropic characteristics of the object to be measured with a higher degree of accuracy compared to the conventional method.

Another measuring device of the present invention comprises a sound wave transmitter transmitting sound waves to an object to be measured, a detector detecting electromagnetic fields generated by the object to be measured due to the sound waves emitted from the sound wave transmitter and a noise processor reducing or eliminating noise in the electromagnetic fields by performing operations on the detection results from at least two directions by the detector.

According to this measuring device, when detecting the electromagnetic fields from the object to be measured generated by the sound wave irradiation described above, the detector can detect the electromagnetic fields from multiple directions that differ from each other or at multiple locations that differ from each other. Therefore, it is possible to evaluate the anisotropic characteristics of the object to be measured with a higher degree of accuracy compared to the conventional method. In addition, noise in the electromagnetic fields can be reduced or eliminated by the noise processor that performs operations on the detection results of the electromagnetic fields. As a result, the measurement device can evaluate the electromagnetic field with less or no noise, and thus can evaluate the anisotropy of the object to be measured with a higher degree of accuracy.

One method of measurement of the present invention comprises a transmitting step for transmitting sound waves to an object to be measured, a detection step for detecting electromagnetic fields from multiple directions that differ from each other or at multiple locations that differ from each other, generated by the object to be measured due to the sound waves emitted and an evaluation step for evaluating anisotropic characteristics of the object to be measured based on the detection results of the electromagnetic fields detected in the detection step.

According to this measurement method, in the detection step for detecting the electromagnetic fields from the object to be measured generated by the transmitting step described above, it is possible to detect the electromagnetic fields from multiple directions that differ from each other or at multiple locations that differ from each other.

Therefore, it is possible to evaluate the anisotropic characteristics of the object to be measured with a higher degree of accuracy in the evaluation step compared to the conventional method.

Another method of measurement of the present invention comprises a transmitting step for transmitting sound waves to an object to be measured, a detection step for detecting electromagnetic fields generated by the object to be measured due to being irradiated with sound waves from at least two directions and an evaluation step for evaluating anisotropic characteristics of the object to be measured based on the relationship between the detection results of the electromagnetic fields from at least two directions detected in the detection step.

According to this measurement method, since the electromagnetic fields can be detected from at least two directions in the detection step for detecting the electromagnetic fields from the object to be measured generated by the transmitting step described above. Therefore, it is possible to evaluate the anisotropic characteristics of the object to be measured with a higher degree of accuracy in the evaluation step compared to the conventional method.

Another method of measurement of the present invention comprises a transmitting step for transmitting sound waves to an object to be measured, a detection step for detecting electromagnetic fields generated by the object to be measured due to being irradiated with sound waves from at least two directions and a noise processing step for reducing or eliminating noise contained in the electromagnetic fields by performing operations on the detection results of the electromagnetic fields from at least two directions detected in the detecting step described above.

According to this measurement method, since the electromagnetic fields can be detected from at least two directions in the detection step for detecting the electromagnetic fields from the object to be measured generated by the transmission step described above, it is possible to evaluate the anisotropic characteristics of the object to be measured with a higher degree of accuracy in the evaluation step compared to the conventional method. In addition, noise in the electromagnetic fields can be reduced or eliminated by the noise processing step that performs operations on the detection results of the electromagnetic fields. As a result, the measurement method can evaluate the electromagnetic field with less or no noise, and thus can evaluate the anisotropy of the object to be measured with a higher degree of accuracy.

As described below, an example of the detector described above comprises at least one detector detecting the electromagnetic fields generated by the object to be measured due to the irradiation of sound waves from the sound wave transmitter described above.

Unless duplicated, the other example of the above measurement device or measurement method may further comprise a noise processor or noise processing step that reduces or eliminates noise contained in the electromagnetic fields by operations by the detector or by operations using the detection results of the electromagnetic fields from at least two directions in the detection step.

An example of the detector comprises a first detector detecting the electromagnetic fields generated by the object to be measured due to being irradiated with sound waves from the sound wave transmitter, and a second detector located at a different position from the first detector detecting the electromagnetic fields generated by the object to be measured due to being irradiated. The noise processor may reduce or eliminate noise contained in the electromagnetic fields by subtraction using the detection results by the first detector and the detection results by the second detector.

An example of the processing of the noise processor is as follows in the sequence (P1) to (P3).

(p1) The coefficients are obtained by performing Fourier transformation on the detection results by the first detector, referred to as the “first detection result” for convenience of explanation, and on the detection results by the second detector, referred to as the “second detection result” for convenience of explanation, and multiplying the values of the waveform normalized by frequency components of the waveform after the Fourier transformation on the first detection result by the first detector and the complex conjugate values of the waveform normalized by frequency components of the waveform after the Fourier transformation on the second detection result by the second detector.

(p2) The frequency components whose coefficients are less than a specific value are cut off from the first detection results by the first detector after the Fourier transformation and the second detection result by the second detector after the Fourier transformation.

(p3) Inverse Fourier transformation on the first detection result by the first detector after the Fourier transformation after the removal in (p2) and on the second detection result by the second detector after the Fourier transformation after the removal in (p2) is performed, and the difference between the first detection result by the first detector after the inverse Fourier transformation and the second detection result by the second detector after the inverse Fourier transformation is taken.

An example of the second detector, which plays the role of the detector described above, may have a shape surrounding the first detector.

One example of the sound wave transmitter may further comprise an image processor scanning the sound waves over a two-dimensional surface or three-dimensional volume of the object to be measured and imaging the results of the detection of the electromagnetic fields from at least two directions by the detector.

An example of the evaluator may also evaluate the crystallinity of the target to be measured in a specific direction based on the difference of the electromagnetic fields from the two directions by the detector.

An example of the evaluator may also evaluate the degree of orientation of the fiber structure of the object to be measured based on at least one of the difference of the electromagnetic fields from the two directions by the detector or the ratio of the electromagnetic fields from the two directions by the detector.

According to another aspect of the invention, a measurement device is provided.

This measurement device comprises a sound wave transmitter that transmits sound waves to the object to be measured, a detector that detects the electromagnetic fields generated by the object to be measured due to irradiation of the sound waves from the sound wave transmitter, and a noise processor that reduces or eliminates noise in the electromagnetic fields by performing operations on the detection results of the electromagnetic field from at least two directions by the detector.

An example of the detector comprises a first detector detecting the electromagnetic fields generated by the object to be measured due to irradiation of the sound wave from the sound wave transmitter, and a second detector located at a different position from the first detector detecting the electromagnetic field generated by the object to be measured due to irradiation of the sound wave. The noise processor may reduce or eliminate the noise contained in the electromagnetic fields by subtraction using the detection results by the first detector and the detection results by the second detector.

### Advantageous Effects of Invention

According to the present disclosure, it is possible to provide a measurement device and a measurement method for qualitatively and/or quantitatively evaluating the orientation of a tissue having a crystal or fiber structure by reducing or eliminating extraneous noise when evaluating the tissue using an acoustically stimulated electro magnetic method.

### BRIEF DESCRIPTION OF DRAWINGS

FIG. 1 shows an electromagnetic field induced by irradiating a sound wave to a part of an object to be measured.

FIG. 2 shows an example configuration of the measurement device according to the first embodiment.

FIG. 3 shows a flow of the measurement process using the measurement device.

FIGS. 4A and 4B show an electrical polarization induced in an object to be measured by irradiation of ultrasonic waves to the object to be measured.

FIGS. 5A-5E show a measurement method of an object to be measured using a measurement device according to the first embodiment.

FIGS. 6A and 6B show a graph showing the strength of the electromagnetic field detected by a measurement device according to the first embodiment by irradiating ultrasonic waves perpendicular to the fiber direction.

FIGS. 7A and 7B show a graph showing the strength of the electromagnetic field detected by a measurement device according to the first embodiment by irradiating ultrasonic waves parallel to the fiber direction.

FIGS. 8A and 8B show shows a case of non-invasive evaluation of a subject to be measured.

FIGS. 9A and 9B show a case of non-invasive evaluation of a subject to be measured.

FIGS. 10A-10C illustrate the calculation method of E_{y}/Eₚ shown in FIGS. 8A and 8B and Eₓ/Eₚ shown in FIGS. 9A and 9B.

FIG. 11 shows the flow of a noise reduction or elimination process by a measurement device according to the first embodiment.

FIGS. 12A-12C illustrate a noise reduction or elimination process by a measurement device according to the first embodiment.

FIGS. 13A-13C show a detector according to variant (1) of the first embodiment.

FIGS. 14A and 14B show another variant of a detector according to variant (1) of the first embodiment.

FIGS. 15A-15E show an example configuration of a measurement device according to variant (2) of the first embodiment.

FIG. 16 shows an example configuration of a measurement device according to variant (3) of the first embodiment.

FIG. 17 shows a measurement device according to variant (4) of the first embodiment.

FIGS. 18A-18D show an example configuration of a measurement device according to variant (5) of the first embodiment.

FIG. 19 shows an example configuration of a measurement device according to variant (6) of the first embodiment.

FIG. 20 shows an example configuration of a measurement device according to variant (7) of the first embodiment.

FIG. 21 shows an example configuration of a measurement device according to variant (8) of the first embodiment.

FIG. 22 shows an example configuration of a measurement device according to variant (9) of the first embodiment.

FIG. 23 shows an example configuration of a measurement device according to variant (10) of the first embodiment.

FIGS. 24A and 24B show an example configuration of a measurement device according to variant (11) of the first embodiment.

FIGS. 25A and 25B show an example configuration of a further variant of a measurement device according to variant (11) of the first embodiment.

FIGS. 26A and 26B show graphs (a) and (b) of the measurement results using a measurement device according to variant (6) of the first embodiment when bovine bone is the object 10 to be measured.

FIG. 27 shows a graph of the measurement results using a measurement device according to variant (6) of the first embodiment when a quartz crystal is the object to be measured.

FIGS. 28A-28C show a graph of the measurement results using a measurement device according to variant (7) of the first embodiment when a gallium arsenide (GaAs) is the object 10 to be measured.

FIG. 29 shows a graph of the measurement results using a measurement device according to variant (6) of the first embodiment when a gallium arsenide (GaAs) is the object to be measured.

FIG. 30A shows an example configuration of a measurement device according to the second embodiment in which two detection sections and a housing that accommodates a sound wave medium are integrated. FIG. 30B shows an example of a photograph of a human arm bone being measured using a measurement device according to the second embodiment.

FIG. 31A shows a graph of the measurement results using a measurement device according to the second embodiment when a human finger is the object to be measured. FIG. 31B shows a graph of the measurement results using a measurement device according to the second embodiment when a human upper arm is the object to be measured.

### DESCRIPTION OF EMBODIMENTS

Embodiments of the invention will be described in detail based on the accompanying drawings. In this description, unless otherwise noted, common parts are marked with a common reference code throughout the Figures. In addition, the elements of this embodiment are not necessarily shown to scale in the Figures. In addition, some signs may be omitted to make each drawing easier to read.

### First Embodiment

In the following description, the case of evaluating biofibrous tissues such as bones, tendons and ligaments as tissues having a fiber structure will be explained. Although thread-like tissues in living organisms are sometimes referred to as “fibers,” they will be referred to as “fibers” in the following description.

Crystals have a certain symmetry due to their atomic arrangement. In tissues such as biological tissues and polymeric fiber materials, although exact periodicity at the atomic scale is not ensured, at a more macroscopic scale, they may have a certain periodic structure. For example, fibrous polymers may form bundles that are aligned in a certain direction, and these molecular bundles may gather together to form larger fibrous bundles in a hierarchical structure. As a result of his intensive research on the symmetry of the atomic arrangement or fiber structure of the object to be measured, the inventor has found that the magnitude and direction of the electric polarization (or piezoelectric polarization) induced by sound wave irradiation can be determined according to the symmetry of the crystal or fiber structure. As explained below, the inventor has invented a technique to quantitatively evaluate the crystallinity or orientation of a tissue with a fiber structure when the tissue is evaluated using the acoustically stimulated electromagnetic method. When the magnitude of the electric polarization is proportional to the sound pressure, it may be regarded as piezoelectric polarization. The characteristic in which the magnitude of the electric polarization is proportional to the sound pressure may also be regarded as a piezoelectric characteristic. However, this embodiment is not limited to the case that the magnitude of the electric polarization is proportional to sound pressure if the magnitude and direction of the electric polarization induced by sound wave irradiation is determined according to the symmetry of the crystal or fibrous structure.

In general, tissues with fibrous structures have high tensile strength relative to the direction of their orientation. Thus, fiber tissues such as bones, tendons and ligaments of locomotor organs maintain proper orientation to withstand mechanical loading. Inflammatory cytokines are released and fibroblasts assemble at the site of inflammation to repair the tissue and produce collagen fibers to repair the damaged tissue when collagen fiber tissue is damaged. The newly produced collagen fibers are initially arranged in a disorganized manner at the beginning of the neocollagenesis, however with the application of appropriate mechanical loading such as exercise, the repair of the damaged area is eventually completed with an optimal arrangement that can withstand the loading. Even for calcified bone, it is known that mechanical loading, either gravity or exercise, can increase bone strength. These phenomena mean that the locomotor organs are constantly rebuilding the proper collagen fiber structure to withstand external loading.

The main diagnostic techniques for fiber tissue have been MRI (Magnetic Resonance Imaging, nuclear magnetic resonance imaging), CT (Computed Tomography, computed tomography) and echo, etc. MRI, CT and echo evaluate the shape, thickness and quantity of the target tissue. However, qualitative information on “fiber orientation,” which is fundamental to the mechanical properties of fiber structures, has not been obtained. In the diagnosis of osteoporosis, not only in clinical practice but also in basic research using laboratory animals, bone mineral density evaluation by X-ray CT or DXA (dual-energy X-ray absorptiometry) is the mainstream method, and there is no bone quality diagnostic technique to noninvasively evaluate collagen fibers, which account for half of the bone volume ratio.

The inventor has found that sound waves, e.g., ultrasound, induce electrical polarization, or piezoelectric polarization, not only in bone but also in biological soft tissues. Furthermore, it was found that the anisotropy of the polarization is defined by the crystallinity, orientation, of the fibers. This means that the direction and degree of orientation of the fiber structure can be evaluated from the anisotropy of polarization. The ASEM method can be applied to non-invasive medical diagnostics because it can evaluate and image the polarization of a specific part of the body using sound waves, e.g., ultrasound.

First, the electromagnetic field induced in the area where sound waves are irradiated when the object to be measured is irradiated with sound waves is explained. The details of the electromagnetic field induced in the area where sound waves are irradiated are disclosed in the above

### Patent Literature 1.

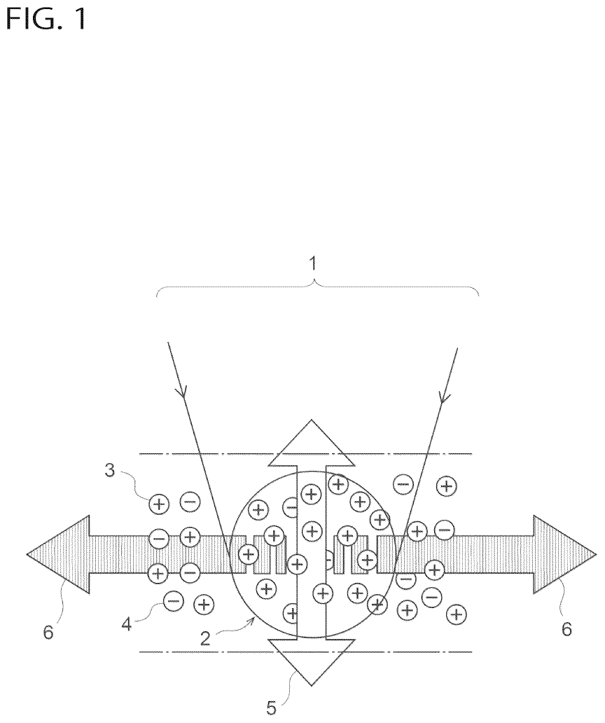

FIG. 1 shows an electromagnetic field induced by irradiating a sound wave to a part of an object to be measured. In FIG. 1, the sound wave focused beam 1 is shown focused on the portion 2 to be measured, and the circled + and − symbols indicate positive charged particles 3 and negative charged particles 4, respectively. In the sound wave focused area 2 of the object to be measured, the concentration of positively charged particles 3 and negatively charged particles 4 is out of balance, therefore a state of charge distribution in which positively charged particles 3 outnumber negatively charged particles 4 is indicated. In addition, arrow 5 indicates the direction of sound wave vibration of the sound wave focused beam 1, which corresponds to the direction of the electric field. Arrow 6 also shows the magnetic field generated in the plane perpendicular to arrow 5.

As shown in FIG. 1, the irradiation of the sound wave focused beam 1 causes the positive charged particles 3 and the negative charged particles 4 to vibrate in the sound wave vibration direction, in the direction of the arrow indicated by the arrow 5, at the frequency of the sound wave. The vibration of the positive charged particles 3 and negative charged particles 4 means the vibration of charges, therefore a magnetic field, in the direction of the arrow indicated by the sign 6, that is generated in the plane perpendicular to the vibration direction 5 is induced. Since the electromagnetic fields generated are out of phase with each other by π, no electromagnetic field is induced because they cancel each other out. However, in the sound wave focused area 2 of the object to be measured, there are more positively charged particles 3 than negatively charged particles 4 in the charge distribution state, consequently they cannot completely cancel each other out and a net electromagnetic field, arrow 6, is induced. Therefore, if the electromagnetic field induced by the sound wave is observed and a change in the intensity of the electromagnetic field is observed, it indicates that a change has occurred in the charge distribution, i.e., a change in the concentration of positively charged particles 3 or negatively charged particles 4, or both. As a result, from the measurement of the electromagnetic field induced by the sound waves, it is possible to measure the characteristic value of the charged particles in the object to be measured, in this case the change in their concentration.

By the way, although FIG. 1 shows an example of measuring changes in the concentration of charged particles from the measurement of the electromagnetic field induced by sound waves, changes in the characteristic values of charged particles that can be measured include not only concentration, but also changes in mass, size, shape, charge number or interaction force with the medium surrounding the charged particles. For example, from some other knowledge of the state of the object to be measured or from knowledge by some other means, if changes in concentration, mass, size, shape and charge number are not possible, changes in the intensity of the measured electromagnetic field can be linked to changes in the interaction force with the medium surrounding the charged particles. Thus, for example, changes in the intensity of the measured electromagnetic field can be linked to changes in the electron or cation polarization rates.

In this embodiment, the electric field, dielectric constant and spatial gradient of the electric field or dielectric constant can be measured as electrical properties of the object to be measured. Also in this embodiment, the magnetization due to electron spin or nuclear spin can be measured as a magnetic property of the object to be measured. Specifically, as in the case of electric polarization, an electromagnetic field is generated when the magnetization varies with time. According to Maxwell's equation, the radiated electric field is proportional to the second derivative of the magnetization with respect to time, see Non-Patent Literature 1. Therefore, it is possible to measure the magnitude and direction of the magnetization from the intensity and phase of the electromagnetic field.

In addition, in this embodiment, it is possible to measure acoustic magnetic resonance caused by electron spin or nuclear spin as a magnetic property of the object to be measured. Specifically, it is expected that at a certain resonance frequency, sound waves are efficiently absorbed and the direction of the electron spin or nuclear spin changes, so that the intensity and phase of the electromagnetic field changes significantly at that frequency. As information, the resonance frequency can be determined. In addition, as in ordinary ESR, electron spin resonance, and NMR, nuclear magnetic resonance, scanning the frequency of the sound wave will provide a spectrum, and information on electron spin and nuclear spin can be obtained. In addition, the relaxation time of electron spin and nuclear spin can be measured.

Also in this embodiment, the piezoelectric or magnetostrictive properties can be measured as electromechanical or magnetomechanical properties of the object to be measured as follows. In principle, ionic crystals without inversion symmetry are subject to electrical polarization due to strain. Therefore, the magnitude of the polarization can be obtained from the intensity of the electromagnetic field of the object to be measured, which can be called the sound wave induced electromagnetic field. By scanning the sound waves, the piezoelectric properties of the object to be measured can be imaged. Furthermore, from the direction of sound wave propagation and the angular distribution of the electromagnetic field generated, the piezoelectric tensor can be measured without electrodes on the object to be measured in a non-contact manner.

In addition, in this embodiment, the magnetostriction property can be measured as an electromechanical or magneto-mechanical property of the object to be measured as follows. Magnetostriction is a phenomenon in which the electron orbitals are changed due to crystal distortion and a change is applied to the electron spin magnetization through orbital-spin interactions. In other cases, the magnetic domain structure is changed by external strain, resulting in a change in the effective magnetization in a macroscopic region, about the size of a sound wave beam spot. Crystal distortion can also cause changes in the crystal field splitting, which can alter the electronic state and change the magnitude of the electron spin magnetization. These temporal changes are thought to generate electromagnetic fields. Therefore, the magnitude of magnetization, orbital-spin interaction, sensitivity to crystal distortion and electron orbital change, sensitivity to crystal field splitting and distortion, relationship between crystal field splitting and electron spin state, or relationship between magnetic domain structure and distortion can be determined from the intensity of the sound wave induced electromagnetic field. From the direction of sound wave propagation and radiation intensity, the magnetostriction tensor can be measured in a non-contact manner without electrodes on the object to be measured. Imaging of the magnetostrictive properties is also possible, as well as the piezoelectric properties.

In this embodiment, a sound wave is irradiated to the object to be measured and the electromagnetic field generated by this object is measured. In this embodiment, sound waves generated based on predetermined information are irradiated to the object to be measured, and the electromagnetic field generated by the irradiation to the object to be measured is detected. Based on at least one measurement selected from the group consisting of the intensity, phase and frequency of the detected electromagnetic field, at least one characteristic selected from the group consisting of the electrical, magnetic, electromechanical and magnetomechanical characteristics of the object to be measured can then be extracted.

Thus, as electrical properties of the object to be measured, it is possible to measure changes in at least one characteristic value selected from the group consisting of the electric field, dielectric constant, spatial gradient of the electric field or dielectric constant, concentration, mass, size, shape, number of charges and interaction of charged particles with the medium surrounding the charged particles in the object to be measured. As magnetic properties of the object to be measured, it is possible to measure magnetization due to the electron spin or nuclear spin of the object to be measured, and acoustic magnetic resonance due to the electron spin or nuclear spin of the object to be measured. As electromechanical and magnetomechanical properties of the object to be measured, it is possible to measure piezoelectric or magnetostrictive properties of the object to be measured.

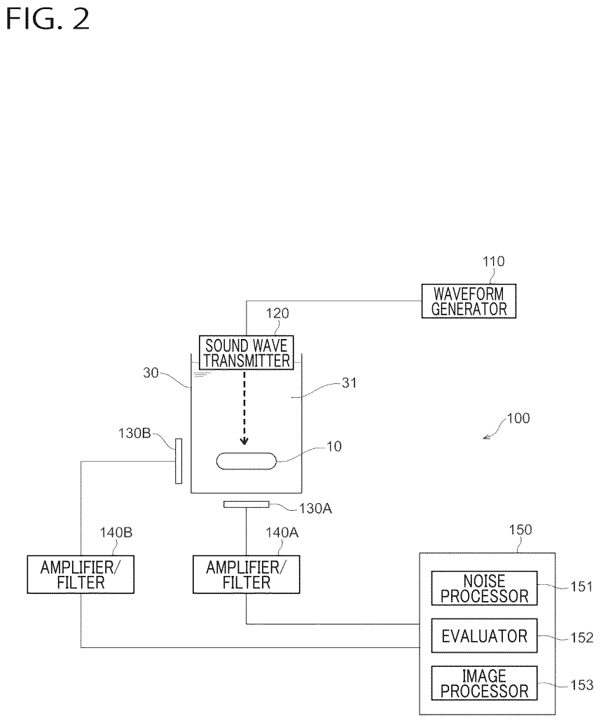

FIG. 2 shows an example configuration of the measurement device 100 according to this embodiment. As shown in FIG. 2, the measurement device 100 according to this embodiment comprises a waveform generator 110, a sound wave transmitter 120, a detector 130A, a detector 130B, an amplifier/filter 140, and a signal processor 150. The measurement device 100 shown in FIG. 2 is a device for measuring the characteristics of an object 10 to be measured. In this embodiment, an object having a tissue with a fiber structure is used as the object 10 to be measured. In FIG. 2, as in the other Figures of this application, the known holding fixture or holding mechanism that holds the object 10 to be measured is omitted. An example of a typical detector is an electrostatically coupled antenna, for example, a metal plate. Various types of antennas, such as loop, electrostatically coupled and array antennas, as well as sensors and array sensors that detect electric charge, electric field, and magnetic field may be used as antenna 130A, antenna 130B, for example. In each embodiment, including the present embodiment, the transmitted sound wave is represented in the Figure by a dotted arrow or broken arrow and is distinguished from a white arrow representing electrical polarization or piezoelectric polarization. In addition, a white arrow representing electrical polarization or piezoelectric polarization is not necessarily depicted in each drawing.

The waveform generator 110 generates a predetermined waveform (e.g., pulse waveform) to generate sound waves such as ultrasonic waves (hereinafter referred to as “ultrasound”) from the sound wave generator 120. The sound wave transmitter 120 transmits ultrasound toward the object to be measured 10 based on the waveform generated by the waveform generator 110 (an example of the transmitting process). Between the sound wave transmitter 120 and the object 10 to be measured, water, as an example of the sound wave medium 31, is present in the tank 30 to temporally separate the reverberation noise caused by the sound wave transmission and the electromagnetic field generated by the object to be measured by the sound wave. Although water is employed as the sound wave medium in the embodiment described above, the sound wave medium is not limited to water in this embodiment. For example, liquids other than water (e.g., various aqueous solutions, alcohols, liquid oils), gases including air, resins or metals can also be employed as sound wave medium 31 to adjust the sound speed. The range of sound wave frequencies in this embodiment is, for example, 10 kHz to 1 GHZ, and in particular, a typical frequency of 0.5 MHz to 10 MHZ.

Th detector 130A and the detector 130B are examples of detectors in this embodiment. One detector, the first detector 130A detects the electromagnetic field, an example of the first electromagnetic field, generated (radiated) by the object 10 to be measured, and another detector, the second detector 130B, detects the electromagnetic field, an example of the second electromagnetic field, generated (radiated) by the object 10 to be measured, in the same way as the first detector 130A. It should be added that in this embodiment, the object detected by the detector 130A and the detector 130B may be referred to as “electromagnetic field” or “electromagnetic field signal,” however the content is substantially the same. The detector 130A and the detector 130B can detect electromagnetic fields. For example, the distance between the sound wave transmitter 120 and the object 10 to be measured is 70 mm, and the distance between the object 10 to be measured and the detectors 130A, 130B is 20 mm.

If the area where the sound wave is irradiated (sound wave irradiated area) is smaller than the object to be measured 10, the above distances should be the distance between the sound wave transmitter 120 or detectors 130A, 130B and the sound wave irradiating portion of the object 10 to be measured.

The case where the sound wave irradiated area is smaller than the object to be measured 10 is, for example, a case where sound waves from the sound wave transmitter 120 are focused to irradiate a portion of the object to be measured 10 and the electromagnetic field generated from the sound wave irradiated area is detected.

The arrangement pattern of the detectors 130A and 130B will be described in detail later, however in one example, the angle between the direction of the electric polarization induced in the object to be measured 10 by the sound wave irradiation from the sound wave transmitter 120 and the direction connecting the center of the electric polarization and the center of the detector 130A may be 90 degrees, and the angle between the direction of the electric polarization and the direction connecting the center of the electric and the direction connecting the center of the electric polarization and the center of the detector 130B may be 45 degrees. For example, the angle between the direction of the electric polarization induced in the object to be measured 10 by the sound wave irradiation from the sound wave transmitter 120 and the direction connecting the center of the electric polarization and the center of the detector 130A may be 90 degrees, and the angle between the direction of the electric polarization and the direction connecting the center of the electric and the direction connecting the center of the electric polarization and the center of the detector 130B may be 54.7 degrees. the angle between the direction of the electric polarization induced in the object 10 to be measured by the sound wave from the sound wave transmitter 120 and the direction connecting the center of the electric polarization and the center of the detector 130A is 90 degrees, and the angle between the direction of the electric polarization and the direction connecting the center of the electric polarization and the center of the detector 130B is 54.7 degrees. Of course, patterns of arrangement of the detectors 130A and 130B are not limited to the pertaining examples.

The amplifier/filter 140A and the amplifier/filter 140B amplify and filter the electromagnetic fields detected by the detector 130A and the detector 130B, respectively. In this embodiment, the amplifier/filter 140A and 140B amplify the electromagnetic fields detected by the detector 130A and the detector 130B by a predetermined amount and pass them through a bandpass filter to reduce or remove bands other than the predetermined frequency band, an example of noise processing process. The predetermined frequency band is, for example, 3.4 MHz to 3.6 MHZ.

The signal processor 150 extracts the characteristics of the object 10 to be measured based on the electromagnetic field that has passed through the amplifier/filter 140A and the amplifier/filter 140B. The signal processor 150 includes a noise processor 151, an evaluator 152 and an image processor 153.

The noise processor 151 reduces or removes noise contained in the electromagnetic fields detected by the detectors 130A and 130B using the electromagnetic fields detected by the detectors 130A and 130B. The details of the noise reduction or removal process by the noise processor 151 will be described later. For example, the noise processor 151 performs subtraction of the electromagnetic fields detected by the detectors 130A, 130B, so that the noise in the electromagnetic fields detected by the detectors 130A, 130B is canceled out and the noise is reduced or removed. This noise is caused by background electric fields, i.e., extraneous noise, coming from far away.

The evaluator 152 uses the electromagnetic fields detected by the detectors 130A, 130B to evaluate the characteristics related to the anisotropy of the object 10 to be measured, an example of an evaluation process. Specifically, the evaluator 152 uses the electromagnetic fields detected by the detectors 130A, 130B to evaluate the crystallinity of the object 10 to be measured in a specific direction. For example, when the object 10 to be measured has a fiber structure, the evaluator 152 evaluates how much the fiber structure of the object 10 to be measured is oriented in which direction.

By the way, in this embodiment, “characteristics related to anisotropy” includes the meaning of “characteristics related to anisotropy of polarization” and “characteristics related to anisotropy of the object to be measured”. And the aforementioned “characteristics related to anisotropy of polarization” includes the meaning of “direction of polarization,” “magnitude of polarization” and “degree of anisotropy of polarization.” On the other hand, characteristics related to anisotropy of the object to be measured “includes the meaning of “crystalline direction” and “degree of crystallinity,” and if the object to be measured is a fiber structure, it includes the meaning of “orientation direction” and “degree of orientation. By measuring the “characteristics related to anisotropy of polarization,” it is possible to know the “characteristics related to anisotropy of the object to be measured.”

If the object to be measured 10 has a random structure with low crystallinity or orientation, the electric polarization induced in each local region of the object to be measured 10 irradiated by the sound wave transmitter 120 is not necessarily aligned in a certain direction but occurs in a random orientation. The detection result by the detectors 130A and 130B is the sum of the electric polarizations induced in the above local areas within the sound wave irradiation area. If the crystallinity or orientation of the object to be measured 10 is low within the sound wave irradiation area, the difference in detection results by the detectors 130A, 130B is small. Conversely, when the crystallinity or orientation of the object 10 to be measured is high within the sound wave irradiation area, the difference in the detection results by the detectors 130A, 130B becomes large. Therefore, the evaluator 152 can evaluate the characteristics related to the anisotropy of the object to be measured within the sound wave irradiation area based on the relationship between the detection results of the detectors 130A and 130B, which are arranged at different positions.

Specifically, the evaluator 152 evaluates the characteristics related to the anisotropy of the object 10 to be measured by operations on the electromagnetic fields detected by the detectors 130A, 130B. For example, the evaluator 152 evaluates the characteristics related to the anisotropy of the object 10 to be measured by peak-to-peak of the pulse waveform of the signal voltage corresponding to the strength of the electromagnetic field, absolute value, integration of the envelope for a certain time domain, and the like. The evaluation of the anisotropic characteristics of the object 10 to be measured is described in detail below.

The image processor 153 performs image processing to image the detection results of the electromagnetic fields detected by the detectors 130A, 130B. By scanning over a two-dimensional surface, i.e., plane or depth direction, or a three-dimensional volume of the object 10 to be measured with ultrasonic waves from the sound wave transmitter 120, and by having the image processor 153 image the detection results of the electromagnetic fields detected by the detectors 130A, 130B, the measurement device 100 is able to image the spatial distribution of the anisotropy of the object 10 to be measured. The scanning of ultrasonic waves by the sound wave transmitter 120 may be mechanical scanning or electronic scanning.

The measurement device 100 can reduce or eliminate noise included in the electromagnetic field detected by the detectors 130A, 130B due to the above configuration. The measurement device 100 can evaluate the characteristics related to the anisotropy of the object 10 to be measured from the electromagnetic fields detected by the detectors 130A, 130B due to the above configuration. Also, the measurement device 100 can image the spatial distribution of the anisotropy of the object 10 to be measured by imaging the detection results of the electromagnetic fields detected by the detectors 130A, 130B due to the above configuration.

Next, the operation of the measurement device 100 will be described.

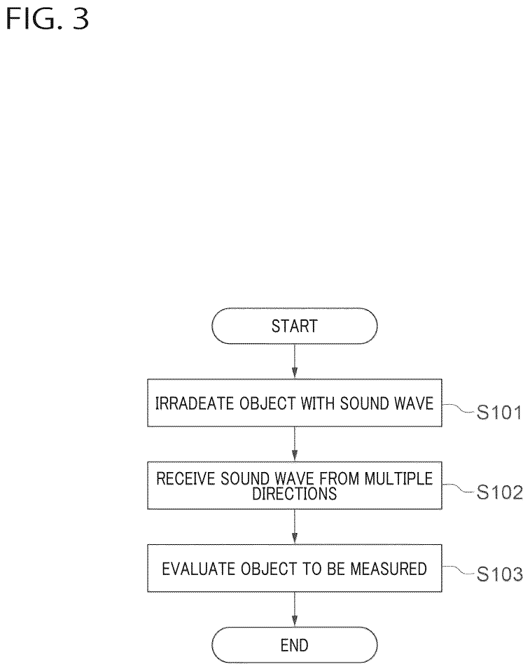

FIG. 3 is a flowchart showing the flow of the measurement process by the measurement device 100. The measurement process is performed by the CPU (Central Processing Unit) of the computer connected to the measurement device 100, which reads a computer program, expands it in RAM (Random Access Memory), executes it and controls each element of the measurement device 100.

First, in step S101, the measurement device 100 transmits ultrasonic waves from the sound wave transmitter 120 to the object 10 to be measured.

Then, in step S102, the measurement device 100 detects the electromagnetic field generated by the object 10 to be measured due to the ultrasonic wave irradiation from the sound wave transmitter 120 with the detectors 130A, 130B.

Then, in step S103, the measurement device 100 evaluates characteristics related to the anisotropy of the object 10 to be measured based on the electromagnetic fields detected by the detectors 130A, 130B. Specifically, the measurement device 100 evaluates the characteristics related to the anisotropy of the object 10 to be measured by peak-to-peak of the pulse waveform of the signal voltage corresponding to the strength of the electromagnetic field, absolute value, integration of the envelope for a certain time region and the like.

It is possible to obtain a two-dimensional image and a tomographic image of the object 10 to be measured by scanning the ultrasonic transducer that detects the electric polarization induced in the object 10 to be measured by the irradiation of ultrasonic waves to the object 10 to be measured from the sound wave transmitter 120 by the detectors 130A, 130B. It is important to note that the detection signal is maximum when the polarization is perpendicular to the detection plane of the detectors 130A, 130B. The detection signal is ideally zero when the polarization is parallel to the detection plane of the detectors 130A, 130B.

The piezoelectricity of the fiber tissue is known to have a non-zero component caused by shear stress, i.e., piezoelectric coefficient d₁₄, and by tensile and compressive stress, i.e., piezoelectric coefficients d₃₁, d₃₂, d₃₃. It should be noted that d₃₁ is the component that polarizes in the third axis direction when compressive or tensile stress is applied in the first axis direction, d₃₂ is the component that polarizes in the third axis direction when compressive or tensile stress is applied in the second axis direction and d₃₃ is the component that polarizes in the third axis direction when compressive or tensile stress is applied in the third axis direction. In addition, d₁₄ is the component that polarizes in the first axis direction or in the second axis direction when shear stress is applied. Here, the direction of fiber orientation is assumed to be the third axis direction. It is expected that the polarization induced in the tissue by ultrasound is the polarization of the d₃ᵢ, i=1, 2, 3, component since normal ultrasound is a longitudinal wave. Based on this anisotropy, the measurement device 100 evaluates the characteristics related to the anisotropy of the object 10 to be measured.

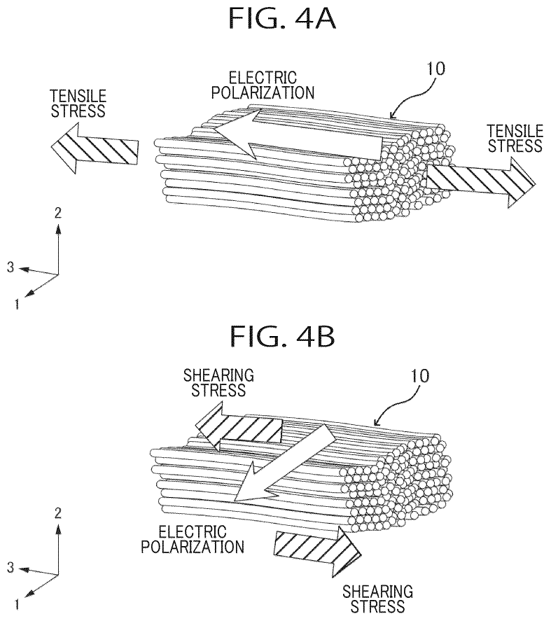

FIGS. 4A and 4B illustrate the electrical polarization induced in the object to be measured 10 by irradiation of ultrasonic waves to the object to be measured 10. FIG. 4A illustrates the d₃₃ polarization and FIG. 4B illustrates the d₁₄ polarization. In the ASEM method, ultrasound is given to apply a time-varying stress Tⱼ(t) at a high frequency, i.e., the frequency of the ultrasound, and the resulting induced time-varying electrical polarization Pᵢ(t) is detected. The relationship between Tⱼ(t) and Pᵢ(t) is expressed by the following equation. In the following equation, i is the direction of polarization and j is the direction of stress application.

Pᵢ(t)=dᵢⱼTⱼ(t)

Thus, polarization appears in accordance with the direction of orientation. The measurement device 100 can detect the electromagnetic field at the detectors 130A, 130B provided at multiple locations and use the strength of the electromagnetic field to evaluate the characteristics of the object 10 to be measured.

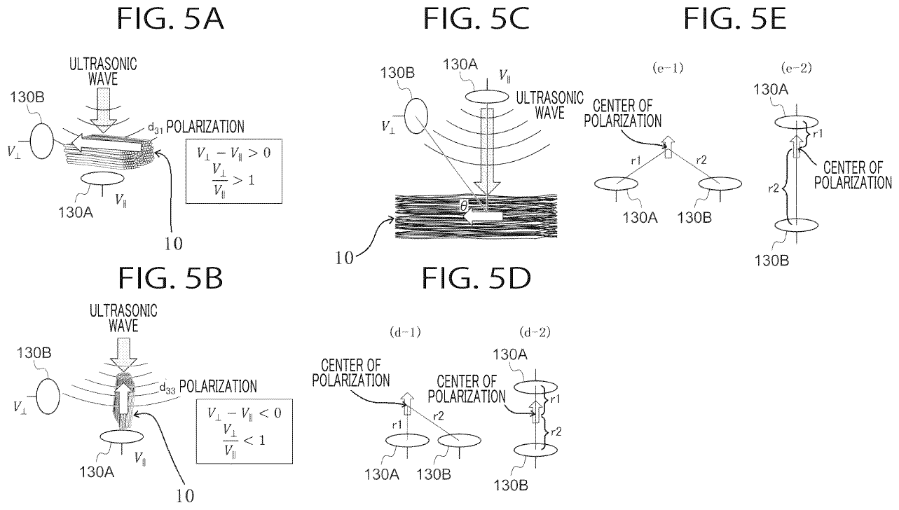

FIGS. 5A-5E illustrate a method of measuring the object 10 to be measured using the measurement device 100. FIG. 5A is an example of evaluating the anisotropic properties of the object 10 to be measured by generating d₃₁ polarization by irradiating ultrasonic waves perpendicular to the fiber direction. FIG. 5B is an example of evaluating the anisotropic properties of the object 10 to be measured to be measured by generating d₃₃ polarization by irradiating ultrasonic waves parallel to the fiber direction. One detector 130A is for detecting polarization in the direction parallel to the ultrasound irradiation direction, and the other detector 130B is for detecting polarization in the direction perpendicular to the ultrasound irradiation direction.

The measurement device 100 enables non-invasive evaluation of the object 10 to be measured. When ultrasound is incident from outside the body to evaluate fiber tissue such as bones and tendons in the body, the detectors 130A and 130B must be installed outside the body, therefore they may not be installed in the direction of fiber orientation. In such a case, these detectors are installed at the angle θ between the direction of ultrasonic wave incidence and the polarization, and the characteristics related to the anisotropy of the object 10 to be measured are evaluated. FIG. 5C is an example of non-invasive evaluation of the object 10 to be measured. By irradiating sound waves to the object to be measured and detecting electromagnetic fields in multiple directions, evaluation regarding the anisotropy of the object to be measured can be performed non-invasively.

The measurement device 100 also makes it possible to reduce or eliminate noise contained in the electromagnetic fields detected by the detectors 130A, 130B. FIGS. 5D and 5E are examples of reducing or eliminating noise contained in the electromagnetic fields detected by the detectors 130A, 130B. The r1 shown in FIG. 5D is the distance from the center of polarization to the detector 130A, and r2 is the distance from the center of polarization to the detector 130B. As shown in FIGS. 5D and 5E, the distance r1 and the distance r2 are equidistant, (e-1) in FIG. 5E, approximately equidistant, (d-2) in FIG. 5D and clearly different, (d-1) in FIG. 5D and (e-2) in FIG. 5E, whichever is selected from this group, the effect of this embodiment can be achieved. The noise contained in the electromagnetic fields detected by the detectors 130A and 130B can be reduced or eliminated by performing arithmetic operations on the electromagnetic fields detected by the detectors 130A and 130B, for example by subtracting the electromagnetic field detected by the detector 130B from the electromagnetic field detected by the detector 130A. Therefore, making the distance r1 and the distance r2 equidistant or substantially equidistant is one of the preferred aspects from the viewpoint that the noise can be reduced or eliminated with a high degree of accuracy by inverting the phase.

First, an example of evaluating the anisotropic properties of the object 10 to be measured by generating d₃₁ polarization by irradiating ultrasonic waves perpendicular to the fiber direction will be described.

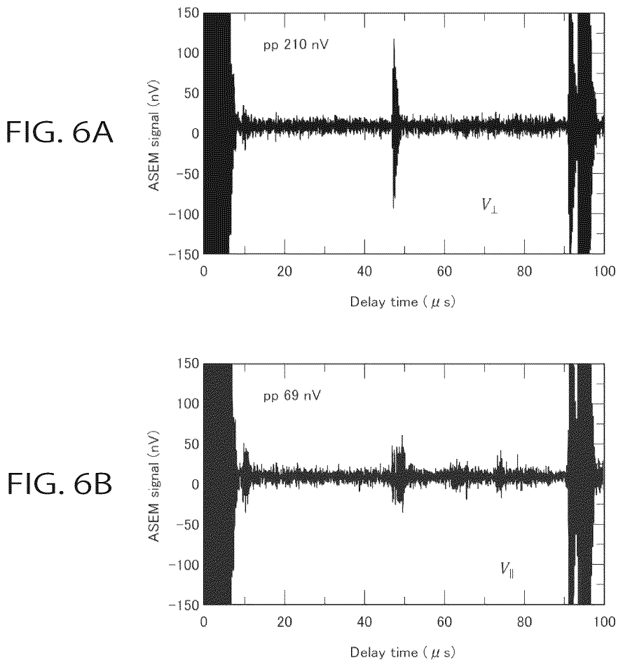

FIGS. 6A and 6B are graphs showing the strength of the electromagnetic field detected by the detectors 130A, 130B located at a position corresponding to FIG. 5A by irradiating ultrasound perpendicular to the fiber direction.

FIG. 6A is an example of the signal V⊥ detected by the detector 130B for detecting polarization in the direction perpendicular to the ultrasound irradiation direction, and FIG. 6B is an example of the signal V∥ detected by the detector 130A for detecting polarization in the direction parallel to the ultrasound irradiation direction. The horizontal axis of each graph shows the elapsed time from the start of ultrasonic wave irradiation, i.e., the time of sound wave generation is set to time 0, and the vertical axis shows the intensity of the signal of the electromagnetic field, i.e., ASEM signal, excited by the irradiation of the ultrasonic wave to the object 10 to be measured, expressed as a voltage. The definitions of these vertical and horizontal axes apply to other similar graphs of measurement results. Each graph shows the electromagnetic fields detected by the detectors 130A and 130B integrated 30,000 times.

Polarization occurs in the direction of orientation, d₃₁ polarization. Therefore, if the two detectors 130A and 130B are installed as shown in FIG. 5A, the detection signal of the detector 130B for detecting polarization in the direction perpendicular to the direction of ultrasound irradiation, FIG. 6A, should be larger than the detection signal of the detector 130A for detecting polarization in the direction parallel to the direction of ultrasound irradiation, FIG. 6B. Therefore, the measurement device 100 can quantitatively indicate the degree of orientation of the tissue by evaluating the difference or ratio of these detection signals, or a combination thereof.

In the process of calculating the difference or ratio of the signals detected by the two detectors 130A and 130B, signals caused by background electric fields, extraneous noise, coming from far away are canceled out. Therefore, the S/N ratio, ratio of signal to noise, can be improved by using two detectors 130A, 130B. In this embodiment, either the value normalized when the ideal orientation state is “1” and the completely random state, no orientation, is “0 (zero)” or the magnitude of variation, standard deviation, from the average value in the orientation direction can be used as an index of “degree of orientation”.

Second, an example of evaluating the anisotropic properties of the object 10 to be measured by generating d₃₃ polarization by irradiating ultrasonic waves perpendicular to the fiber direction will be described.

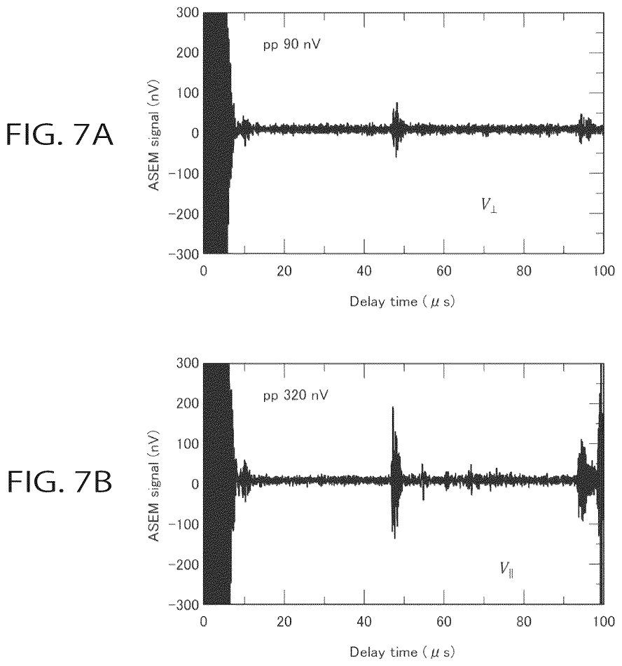

FIGS. 7A and 7B are graphs showing the strength of the electromagnetic field detected by the detectors 130A, 130B located at a position corresponding to FIG. 5A by irradiating ultrasound perpendicular to the fiber direction. FIG. 7A is an example of the signal detected by the detector 130B for detecting polarization in the direction perpendicular to the ultrasound irradiation direction, and FIG. 7B is an example of the signal detected by the detector 130A for detecting polarization in the direction parallel to the ultrasound irradiation direction.

The horizontal axis of each graph is time and the vertical axis is the strength of the electromagnetic field expressed as a voltage. Each graph shows the electromagnetic fields detected by the detectors 130A and 130B integrated 30,000 times.

Polarization occurs in the direction of orientation, d₃₃ polarization. Therefore, if the two detectors 130A and 130B are installed as shown in FIG. 5A, the detection signal of the detector 130B for detecting polarization in the direction perpendicular to the direction of ultrasound irradiation, FIG. 7A, should be larger than the detection signal of the detector 130A for detecting polarization in the direction parallel to the direction of ultrasound irradiation, FIG. 7B. Therefore, the measurement device 100 can quantitatively indicate the degree of orientation of the tissue by evaluating the difference or ratio of these detection signals, or a combination thereof. In the process of calculating the difference or ratio of the signals detected by the two detectors 130A and 130B, signals caused by background electric fields, extraneous noise, coming from far away are canceled out. Therefore, the S/N ratio can be improved by using two detectors 130A, 130B.

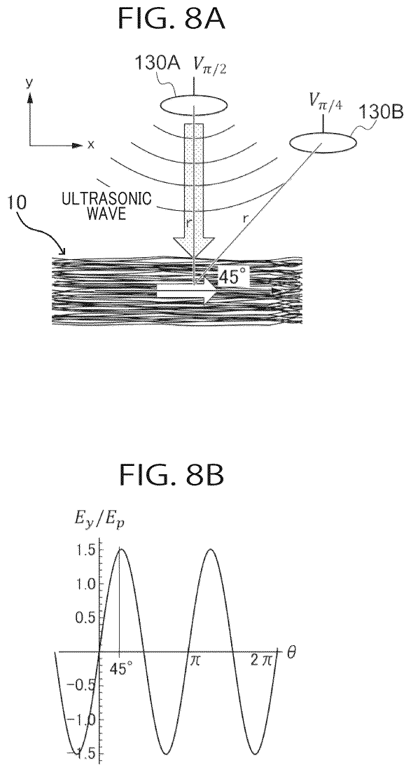

FIGS. 8A and 8B illustrate the case of non-invasive evaluation of the object 10 to be measured. FIG. 8A shows the positions of the detectors 130A and 130B in the case of non-invasive evaluation. The graph in FIG. 8B shows the change in the electric field detected by the detector 130B according to the position of each detector 130B. Eₚ shows the magnitude of the electric field generated by the object 10 to be measured. E_{y} shows the electric field that the detector 130B indicates the magnitude of the detected electric field in the y-axis direction. θ is the angle between the direction of the electric polarization of the object to be measured 10 and the direction connecting the center of the electric polarization and the center of the detector 130B. As shown in FIG. 8B, E_{y}/Eₚ is maximum when 0 is 45 degrees. Therefore, by installing the detector 130B at an angle where θ is 45 degrees or near 45 degrees, e.g., 40 to 50 degrees, it is possible to evaluate the anisotropy of the object 10 to be measured based on the y component of the electric field.

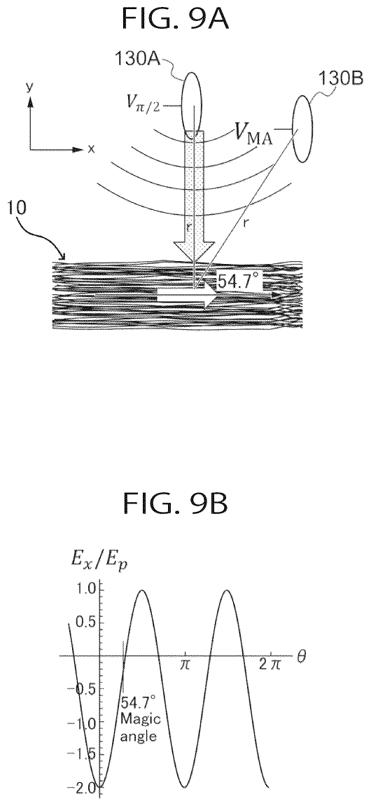

FIGS. 9A and 9B illustrate the case of non-invasive evaluation of the object 10 to be measured. FIG. 9A shows the positions of the detectors 130A and 130B in the case of non-invasive evaluation. The graph in FIG. 9B shows the change in the electric field detected by the detector 130B according to the position of each detector 130B. Eₚ shows the magnitude of the electric field generated by the object 10 to be measured. Eₓ shows the electric field that the detector 130B indicates the magnitude of the detected electric field in the x-axis direction. θ is the angle between the direction of the electric polarization of the object to be measured 10 and the direction connecting the center of the electric polarization and the center of the detector 130B. As shown in FIG. 9B, Eₓ/Eₚ is zero when 0 is 54.7 degrees. Therefore, by installing the detector 130B at an angle where θ is 54.7 degrees or near 54.7 degrees, e.g., 49 to 60 degrees, it is possible to evaluate the anisotropy of the object 10 to be measured based on the x component of the electric field.

The distance r between the two detectors and the center of polarization should be the same, however it may be different. If the distance r is different, an evaluation of the object 10 to be measured can be made by making a correction according to the distance. If the distance from the center of polarization to the two detection areas is different, the signal levels of the two areas may be matched by increasing the area of the farther detection area. A correction based on distance is, for example, a correction to match the distance of one of the detectors from the center of polarization. The area and shape of the detectors 130A and 130B should be the same, however even if they are different, a correction according to area or shape can be used to evaluate the object 10 to be measured. The correction according to area or shape is, for example, a correction to match the area or shape of one of the detectors.

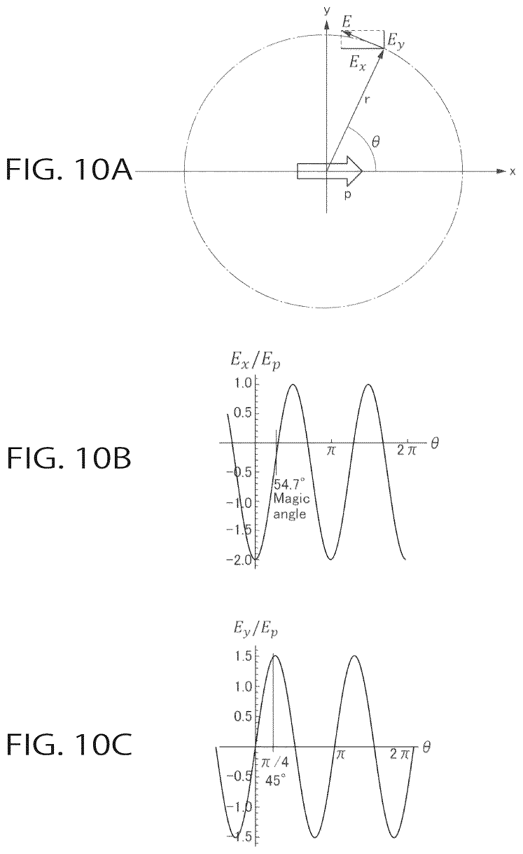

FIGS. 10A and 10B illustrate how E_{y}/Eₚ shown in FIG. 8 and Eₓ/Eₚ shown in FIG. 9 are calculated. In FIG. 10A, the polarization appears in the x-axis direction, and Eₓ and E_{y} on a circle of radius r from the center of polarization are shown. The magnitude of the electromagnetic field, typically the electric field, E(r) on a circle of radius r from the center of polarization is expressed by the following formula.

$$E ( r ) = \frac{1}{4 π {ε}_{0}} \{ \frac{p}{{t}^{3}} - \frac{3 ( p \cdot r ) r}{{r}^{5}} \} \qquad [ equation 1 ]$$

Let Eₓ(r) and E_{y}(r) be the magnitude of the x-axis component of E(r) and the y-axis component of E(r), respectively, then Eₓ(r) and E_{y}(r) are obtained as follows.

$$\begin{matrix}{E}_{x} ( r ) = \frac{p}{4 {πε}_{0} {r}^{3}} ( 1 — 3 {cos}^{2} θ ) \\ {E}_{y} ( r ) = \frac{p}{4 π {ε}_{0} {r}^{3}} ( 3 sin θ cos θ )\end{matrix} \qquad [ equation 2 ]$$

Thus, Eₓ(r) and E_{y}(r) are expressed using E(r) as follows.

$$\begin{matrix}{E}_{x} ( r ) = - {E}_{p} ( 1 - 3 {cos}^{2} θ ) \\ {E}_{y} ( r ) = {E}_{p} ( 3 sin θ cos θ )\end{matrix} \qquad [ equation 3 ]$$

From the above equations, θ at which Eₓ/Eₚ is zero and θ at which E_{y}/Eₚ is maximum can be obtained. FIG. 10 B is a graph showing Eₓ(r) and FIG. 10C is a graph showing E_{y}(r). From FIG. 10(b), the θ at which Eₓ/Eₚ becomes zero is 54.7 degrees and the θ at which E_{y}/Eₚ becomes maximum is 45 degrees. Therefore, by determining the installation location and orientation of the detector based on Eₓ(r) and E_{y} according to the component of the electromagnetic field to be detected, the measurement device 100 can evaluate the object 10 to be measured more accurately than if it were not determined based on Eₓ(r) and E_{y}(r).

Next, the method of reducing or eliminating noise by detecting the electromagnetic field generated by the irradiation of ultrasonic waves to the object 10 to be measured will be described.

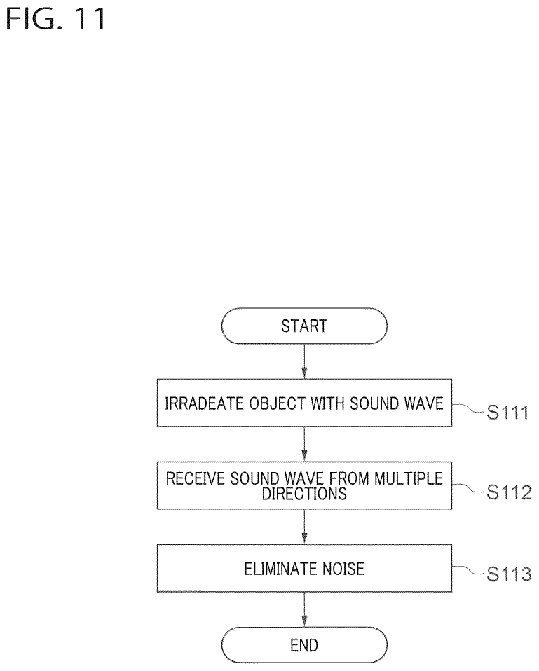

FIG. 11 is a flowchart showing the flow of the noise reduction or elimination process by the measurement device 100. The noise reduction or elimination process by the measurement device 100 is performed by the CPU of a computer connected to the measurement device 100 reading a computer program, expanding it into RAM and executing it to control each element of the measurement device 100.

First, in step S111, the measurement device 100 transmits ultrasonic waves from the sound wave transmitter 120 to the object 10 to be measured.

Then, in step S112, the measurement device 100 detects the electromagnetic field generated by the object 10 to be measured due to the ultrasonic wave irradiation from the sound wave transmitter 120 to the detectors 130A, 130B.

Subsequently, in step S113, the measurement device 100 reduces or eliminates noise contained in the electromagnetic fields detected by the detectors 130A, 130B by operations on the electromagnetic fields detected by the detectors 130A, 130B.

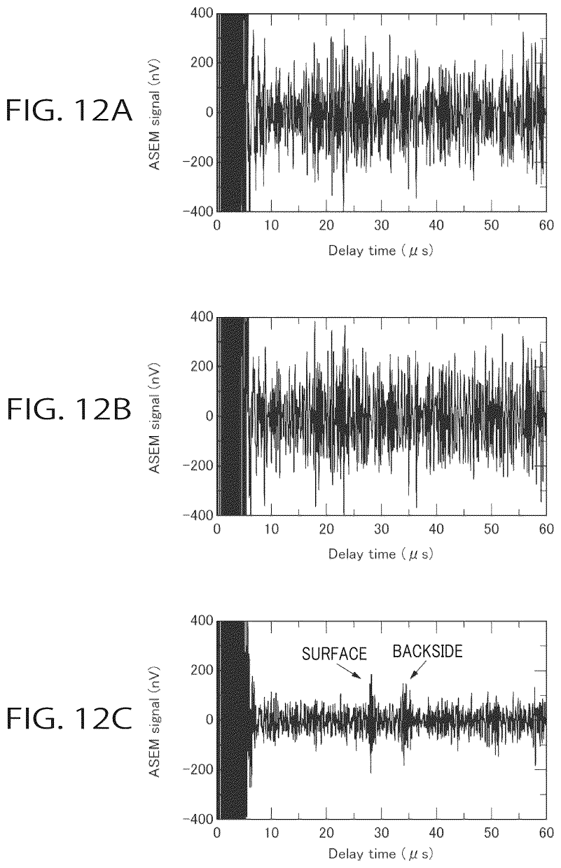

FIGS. 12A-12C illustrate the noise reduction or elimination process by the measurement device 100. FIG. 12A is a graph showing an example of the electromagnetic field detected by detector 130A. FIG. 12 B is a graph showing an example of the electromagnetic field detected by detector 130B. FIG. 12C is a graph subtracting the electromagnetic field detected by detector 130B from the electromagnetic field detected by detector 130A. The horizontal axis of each graph is time, and the vertical axis is the strength of the electromagnetic field expressed in terms of voltage. Here, the surface to which the sound wave was irradiated is the “surface” of the object 10 to be measured, and its backside is the “backside.

As shown in FIGS. 12A-12C, by subtracting the electromagnetic field detected by detector 130B from the electromagnetic field detected by detector 130A, the noise in the electromagnetic fields detected by detectors 130A and 130B can be reduced or eliminated.

Another example of reducing or eliminating noise contained in the electromagnetic fields detected by the detectors 130A, 130B is described. The electromagnetic fields detected by the detectors 130A, 130B include white noise, i.e., intrinsic noise, signals caused by the electromagnetic fields generated by the object 10 to be measured and extraneous noise. Among these, only white noise does not match the shape in the electromagnetic fields detected by the detectors 130A, 130B. In other words, only the white noise does not match the complex phase.

Therefore, the noise processor 151 may reduce or eliminate the noise contained in the electromagnetic fields detected by the detectors 130A, 130B by first reducing or eliminating the white noise and then reducing or eliminating the extraneous noise, as follows.

First, the noise processor 151 performs Fourier transformation on the electromagnetic fields detected by the detectors 130A, 130B. The signal after the Fourier transformation of the electromagnetic field of detector 130A is Z₁(ω) and the signal after the Fourier transformation of the electromagnetic field of detector 130B is Z₂(ω). Z₁(ω) and Z₂(ω) are expressed as follows. Z_{Re1} is the real part of Z₁(ω). Z_{Im1} is the imaginary part of Z₁(ω). Z_{Re2} is the real part of Z₂(ω). Z_{Im2} is the imaginary parts of Z Z₂(ω).

$$\begin{matrix}{Z}_{1} ( ω ) = {Z}_{R e 1} + i {Z}_{I m 1} \\ {Z}_{2} ( ω ) = {Z}_{R e 2} + i {Z}_{I m 2}\end{matrix} \qquad [ equation 4 ]$$

The noise processor 151 normalizes the two transformed waveforms Z₁(ω) and Z₂(ω) to a magnitude of 1 for each frequency component. Let the normalized waveform values be ζ₁ and ζ₂, respectively. Then, ζ₁ and ζ₂ are expressed as the following equations.

$$\begin{matrix}{ζ}_{1} = \frac{{Z}_{1} ( ω )}{\vert {Z}_{1} ( ω ) \vert} = cos θ + i sin θ \\ {ζ}_{2} = \frac{{Z}_{2} ( ω )}{\vert {Z}_{2} ( ω ) \vert} = cos ( θ + ϕ ) + i sin ( θ + ϕ )\end{matrix} \qquad [ equation 5 ]$$

The noise processor 151 then calculates the coefficient by taking the product of ζ₁ and ζ₂* which is the complex conjugate of ζ₂. The coefficient is the real part of ζ₁ζ₂* and is expressed as the following formula. The coefficient includes the information cos φ of the phase difference of the electromagnetic fields detected by the detectors 130A and 130B.

$$Re [ {ζ}_{1} {ζ}_{2}^{*} ] = cos ϕ \qquad [ equation 6 ]$$

The noise processor 151 then cuts off the frequencies for which the above coefficient is less than a specific value from the signal after the Fourier transformation. By cutting off the frequencies whose coefficient is less than a specific value from the signal after the Fourier transformation, the noise processor 151 can reduce or eliminate the white noise included in the electromagnetic fields detected by the detectors 130A, 130B.

The noise processor 151 subsequently performs inverse Fourier transformation on the Fourier transformed signal of which frequencies whose coefficient is below a specific value are cut off to return it to a time domain signal. The noise processor 151 then takes the difference between the inverse Fourier transformed signals. By taking the difference between the signals after the inverse Fourier transformation, the noise processor 151 can reduce or eliminate extraneous noise included in the electromagnetic field detected by the detectors 130A, 130B.

The measurement device 100 according to this embodiment can evaluate the orientation of a tissue having a fiber structure by a simple measurement. The preparation of a special tissue specimen, as in optical microscopic observation, is not necessary for the evaluation of the object 10 to be measured because the measurement device 100 according to this embodiment evaluates the object 10 to be measured by measuring the electromagnetic field excited by ultrasound irradiation,

The measurement device 100 according to this embodiment can also quantitatively evaluate the degree of orientation averaged in the ultrasonically irradiated area. The measurement device 100 according to this embodiment can evaluate the desired coarse-grained orientation information by controlling the range of 0.1 to 100 mm.

The measurement device 100 according to this embodiment is also capable of non-invasive evaluation of tissues and the like in the body. Since the measurement device 100 according to this embodiment is capable of non-invasive evaluation of the subject, it is possible to evaluate the effects in rehabilitation of bones, tendons, ligaments, etc. after injury over time.

The measurement device 100 according to this embodiment is also capable of nondestructive testing for composite materials that contain fibers in the substrate, such as CFRP (carbon fiber reinforced plastic), CMC (ceramic composite material) and PMC (polymer composite material). The measurement device 100 is also capable of in-situ observation and evaluation during material synthesis and during use of products under load.

Although the above embodiment shows an example of performing an evaluation on the anisotropy of the object 10 to be measured by detecting the electromagnetic field generated by the object 10 to be measured using two detectors 130A, 130B, the number of such detectors in this embodiment is not limited to such an example. The measurement device 100 may also perform evaluation regarding the anisotropy of the object 10 to be measured by detecting the electromagnetic field generated by the object 10 to be measured by moving a single detector to a different position. For example, by detecting the electromagnetic field by moving the detector so that the detection area of the electromagnetic field has the relationship as shown in FIG. 8 or FIG. 9, the measurement device 100 can perform the evaluation of the anisotropy of the object 10 to be measured in the same way as when two detectors 130A, 130B are used. When the measurement device 100 performs the evaluation regarding the anisotropy of the object 10 to be measured by detecting the electromagnetic field with one detector, it is desirable to match the conditions of the measurement time and the number of times of integration.

The shape of the detectors 130A, 130B is not limited to the examples described above. For example, for the purpose of reducing or eliminating noise, a sub-detector may be provided around the main detector, and operations to reduce or eliminate noise may be performed from the electromagnetic fields detected by the main and sub-detectors.

### Variant (1) of the First Embodiment

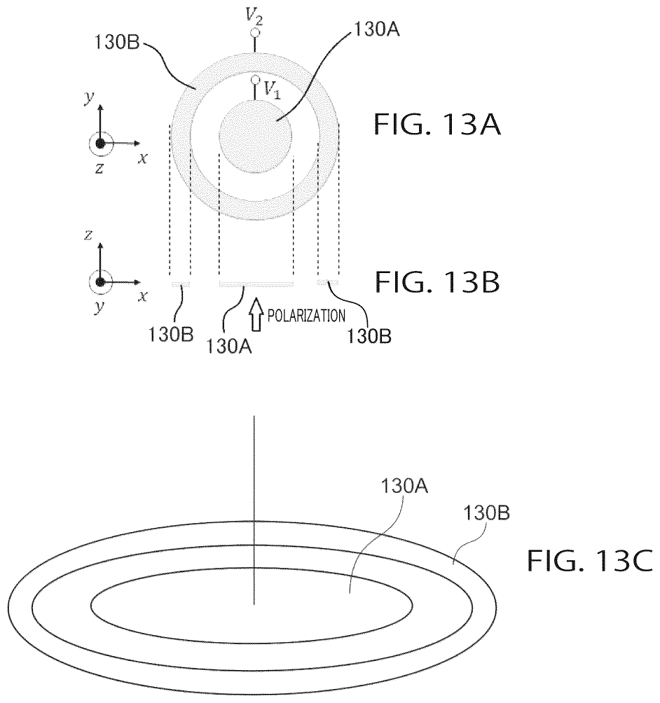

FIG. 13 shows the detectors 130A and 130B of this variant. FIG. 13(a) is a plan view of the detectors 130A, 130B, and FIG. 13(b) is a side view of the detectors 130A, 130B. FIG. 13(c) is a diagonal view of the detectors 130A, 130B. In FIG. 13, the direction of polarization is shown from the bottom to the top of the paper for the sake of explanation.

As shown in FIGS. 13A-13C, it is also one possible arrangement to employ a second detector 130B, which is a sub-detector, to be continuously arranged circumferentially outside of the first detector 130A, which is the main detector, so that it is not tangential to the first detector 130A.

In the variant shown in FIGS. 13A-13C, for example, both the electromagnetic field V₁ detected by the first detector 130A and the electromagnetic field V₂ detected by the second detector 130B detect the z component of the electromagnetic field to be measured. The difference between the electromagnetic field V₁ and the electromagnetic field V₂ is then measured, calculated, to detect the polarization of the z-directional component of the first detector 130A in the central portion and to reduce or eliminate noise in the z-component of the electromagnetic field.

In FIGS. 13A-13C, examples of the shapes of the detectors 130A and 130B are not limited to the aforementioned examples, although an example in which circular and hollow circle-shaped detectors 130A and 130B are employed in plan view will be described. For example, employing rectangular and hollow rectangular shaped detectors 130A, 130B in plan view is also one of preferred aspects. From the viewpoint of reducing or eliminating noise by acquiring differences, it is one of the more preferred aspects of each of the above-mentioned variants that the area of the first detector 130A and the second detector 130B be the same or substantially the same. However, even if the areas of the first and second detectors 130A and 130B are different, it is still possible to reduce or eliminate the noise by calculation for correction.

In FIGS. 13A-13C, the second detector 130B is continuously arranged circumferentially outside the first detector 130A, however this variant is not limited to the example shown in FIGS. 13A-13C.

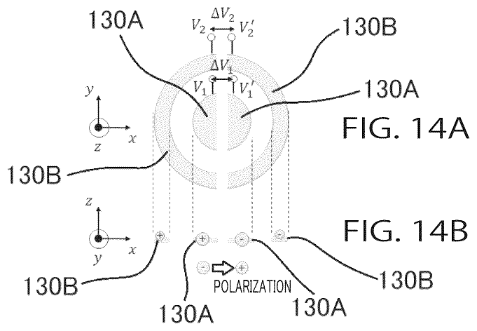

FIGS. 14A and 14B show a further variant of the detectors 130A, 130B shown in FIGS. 13A-13C. FIG. 14A is a plan view of the detectors 130A, 130B, and FIG. 14BB is a side view of the detectors 130A, 130B. In FIGS. 14A and 14B, the charges, positive and negative symbols, are depicted for illustrative purposes, and the direction of polarization, defined as the direction of positive charge from negative charge, is shown.

For example, at least some of the effects of the example shown in FIGS. 13A-13C can be achieved even when the first detector 130A is divided into two parts and the second detector 130B is further arranged circumferentially and discontinuously outside the first detector 130A, as in the configuration shown in FIGS. 14A and 14B.

In the variant shown in FIGS. 14A and 14B, for example, the difference between the electromagnetic fields V₁ and V₁′ detected by the two first detectors 130A, 130A, i.e., ΔV₁, and the difference between the electromagnetic fields V₂ and V₂′ detected by the two second detectors 130B, 130B, i.e., ΔV₂, both detect the x component of the electromagnetic field to be measured. At this time, noise in the y and z components of the electromagnetic field can be reduced or eliminated. The difference between ΔV₁ and ΔV₂ is then measured, calculated, to detect the polarization in the x direction in the vicinity of the first detectors 130A and 130A, and to reduce or eliminate the noise of the x component of the electromagnetic field. The fact that the symbols of the charges of the second detectors 130B, 130B in FIG. 14 are drawn smaller than the symbols of the charges of the first detectors 130A, 130A suggests that the location of the two second detectors 130B, 130B is at a distance from the center of polarization.

In the variant of FIGS. 14A and 14B, as in the variant of FIGS. 13A-13C, the shapes of the detectors 130A, 130B are not limited to a circular and hollow circle-shaped detectors 130A, 130B in plan view. For example, employing rectangular and hollow rectangular shaped detectors 130A, 130B in plan view is also one of preferred aspects. From the viewpoint of reducing or eliminating noise by acquiring differences, it is one of the more preferred aspects of each of the above mentioned variants that the area of the two first detectors 130A, 130A and the two second detectors 130B, 130B be the same or substantially the same. However, even if the areas of the two first detectors 130A, 130A and the two second detectors 130B, 130B are different, it is still possible to reduce or eliminate the noise by calculation for correction.

In addition, another aspect that can be employed is to have the electromagnetic field generated by the object 10 to be measured detected by the respective detectors 130A, 130B by arranging a pair of the first detector 130A and the second detector 130B in multiple locations, as shown in FIGS. 13A-13C.

In the above embodiments and variants, noise is reduced or eliminated by taking a difference for the electromagnetic fields detected by the two detectors 130A, 130B, respectively, but it goes without saying that the configuration of the measurement device 100 is not limited to that shown in FIG. 2.

### Variant (2) of the First Embodiment

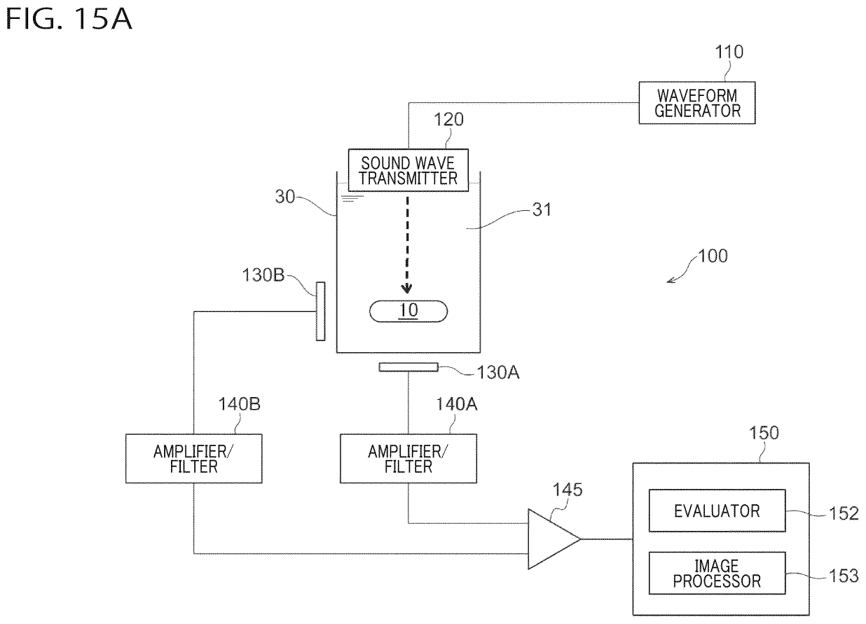

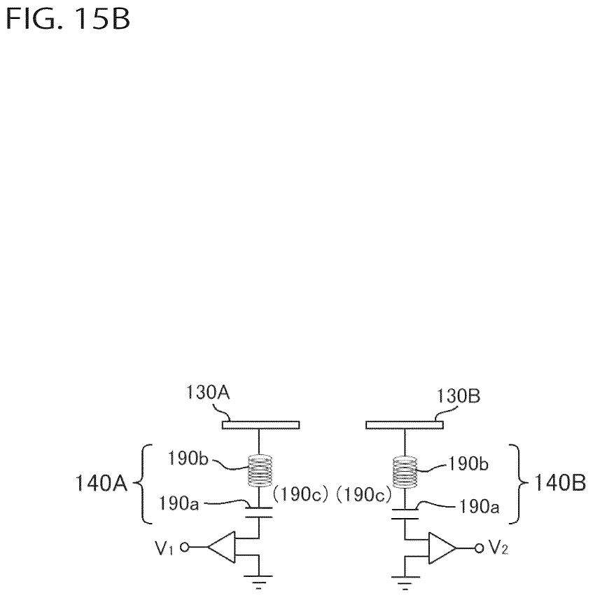

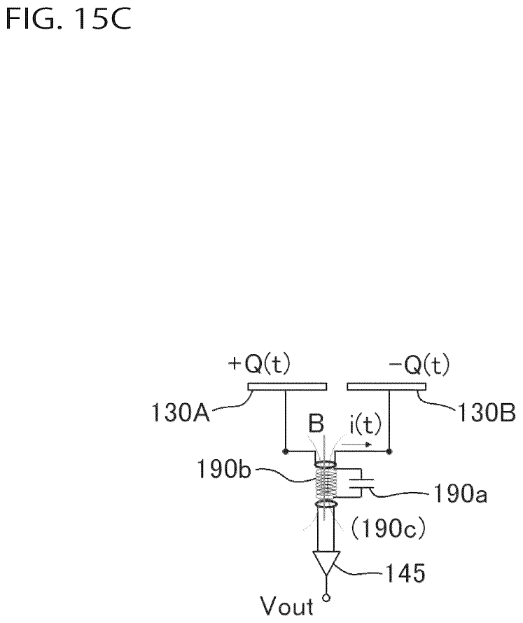

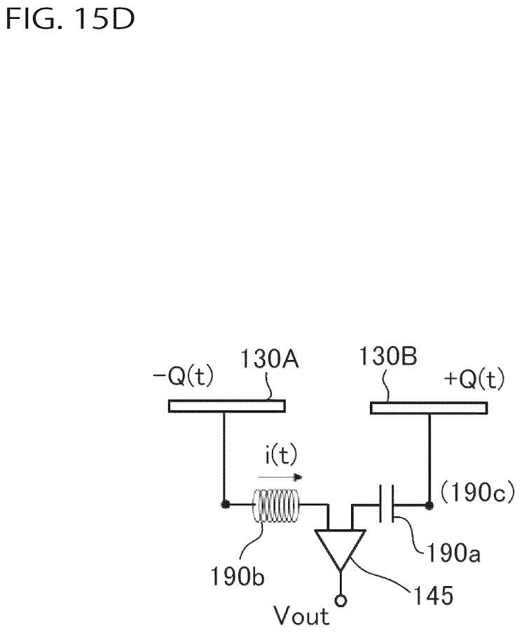

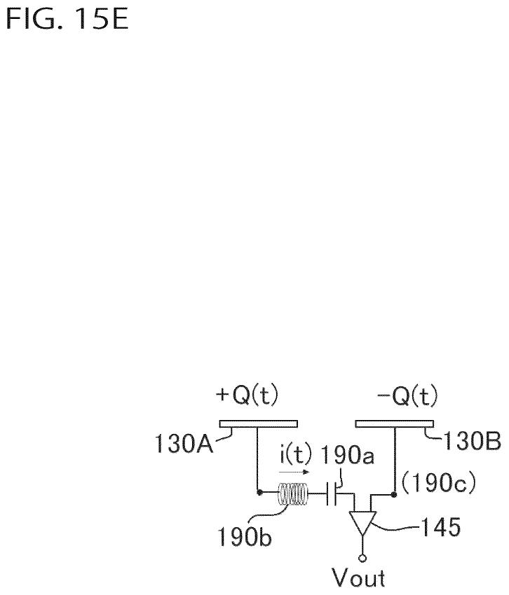

FIGS. 15A-15E shows a variant of the measurement device 100. The measurement device 100 shown in FIG. 15A comprises a differential amplifier 145 that takes the difference of the electromagnetic fields that have passed through the amplifiers/filters 140A and 140B. The differential amplifier 145 can reduce or eliminate noise contained in the signals that pass through the amplifiers/filters 140A and 140B by circuitously taking the difference of the electromagnetic fields that pass through the amplifiers/filters 140A and 140B. Therefore, in this variant, the amplifiers/filters 140A, 140B and the differential amplifier 145 play the role of the amplifiers/filters 140A, 140B and the noise processor 151 in the measurement device 100 of the first embodiment. Similar to the measurement device 100 shown in FIG. 2, the measurement device 100 shown in FIG. 15A can also evaluate the characteristics related to the anisotropy of the object 10 to be measured from the electromagnetic fields detected by the detectors 130A, 130B at the evaluator 152. The measurement device 100, like the measurement device 100 shown in FIG. 2, can also image the spatial distribution of the anisotropy of the object 10 to be measured at the image processor 153 by imaging the detection results of the electromagnetic fields detected by the detectors 130A, 130B.

FIG. 15B shows an example in which the amplifiers/filters 140A and 140B are configured with an LC resonant circuit and an amplifier. In FIG. 15A-15E, the wiring resistance is represented as resistor 190c.

FIGS. 15C, 15D, and 15E are other variations that specifically consist of the differential amplifier 145 and the amplifiers/filters 140A and 140B that can be substituted for the configuration shown in FIG. 15B of this variation example. The respective variations are described below. In each drawing of FIGS. 15A-15E, Q represents charge, B represents magnetic flux density, t represents time, i represents current and V represents voltage. The method of extracting the signal voltage is not limited. For example, the voltage difference between the two detectors 130A and 130B may be extracted as the signal voltage, or the current flowing between the two detectors 130A and 130B may be converted to voltage by an amplifier and extracted as the signal voltage.

In the variant shown in FIG. 15C, the amplifier/filter has the outputs of the two detectors 130A and 130B connected to a metal disc, and the input of the differential amplifier 145 is also connected to the metal disc, thereby placing an LC resonant circuit between these two discs. Since the resonant circuit is indirectly coupled to the detectors 130A and 130B, changes in the resonance characteristics of the resonant circuit are unlikely to occur even if the electrostatic coupling that occurs between the detectors 130A and 130B and the object 10 to be measured changes. This also makes it possible to achieve tuning over a wide bandwidth. Providing a further amplifier to amplify the outputs of the two detectors 130A, 130B is another aspect that can be employed.

In the variant shown in FIG. 15D, the amplifier/filter inputs the output of one of the two detectors 130A, 130B to the differential amplifier via a coil 190B. The output of the other detector 130B is input to the differential amplifier via a capacitor 190a. According to the configuration of this variant, the resonance circuit becomes low impedance, and thus the generation of unwanted noise can be suppressed. Providing a further amplifier to amplify the outputs of the two detectors 130A, 130B is another aspect that can be employed.

In the variant shown in FIG. 15E, the amplifier/filter inputs the output of one of the two detectors 130A, 130B to a differential amplifier via a capacitor 190A and a coil 190B. The output of the other detector 130B is directly input to the differential amplifier. In this variant configuration, as in the variant shown in FIG. 15D above, the resonance circuit becomes low impedance, and thus the generation of unwanted noise can be suppressed. Providing a further amplifier to amplify the outputs of the two detectors 130A, 130B is another aspect that can be employed.

### Variant (3) of the First Embodiment

This variant is similar to the first embodiment and variant (2) of the first embodiment, except that the differential amplifier 145 and the image processor 153 are excluded from FIGS. 15A-15E, therefore redundant explanations may be omitted.

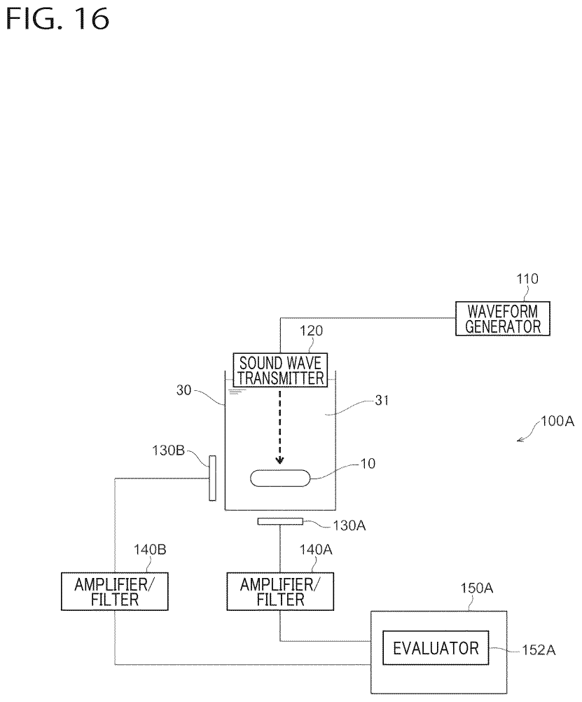

FIG. 16 shows an example configuration of the measurement device 100A according to this variant for an object 10 to be measured, which is placed in a sound wave medium 31 in a tank 30.

In this variant, the differential amplifier 145 is not provided, however the evaluator 152 can directly acquire the electromagnetic field detected by the detectors 130A, 130B to evaluate the characteristics related to the anisotropy of the object 10 to be measured, as in variant (2) of the first embodiment. In other words, instead of the differential amplifier 145 and the amplifiers/filters 140A, 140B, the evaluator 152A and the amplifiers/filters 140A, 140B can also reduce or eliminate the noise contained in the signal of the detected electromagnetic field by taking the role of differential processing and filtering of the signal of the electromagnetic field. Although it is preferable that the image processor 153 is used to image the spatial distribution of the anisotropy of the object 10 to be measured, the image processor 153 is not necessarily required in the characterization of the anisotropy of the object 10 to be measured.

### Variant (4) of the First Embodiment

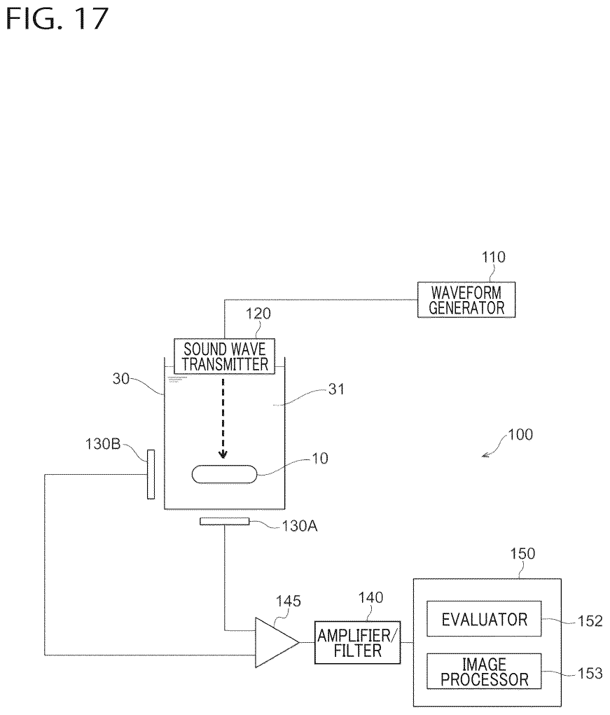

FIG. 17 shows a variant of the measurement device 100. The measurement device 100 shown in FIG. 14 comprises a differential amplifier 145 that takes the difference between the electromagnetic fields detected by the detectors 130A, 130B and an amplifier/filter 140 that performs amplification and filtering on the signals output by the differential amplifier 145. The differential amplifier 145 can reduce or eliminate noise contained in the electromagnetic fields detected by the detectors 130A and 130B by circuitously taking the difference of the electromagnetic fields that passed through the detectors 130A and 130B. Similar to the measurement device 100 shown in FIG. 2, the measurement device 100 shown in FIG. 17 can evaluate the characteristics related to the anisotropy of the object 10 to be measured from the electromagnetic fields detected by the detectors 130A, 130B with the evaluator 152. The measurement device 100 shown in FIG. 17, like the measurement device 100 shown in FIG. 2, can image the spatial distribution of the anisotropy of the object 10 to be measured at the image processor 153 by imaging the detection results of the electromagnetic fields detected by the detectors 130A, 130B.

### Variant (5) of the First Embodiment

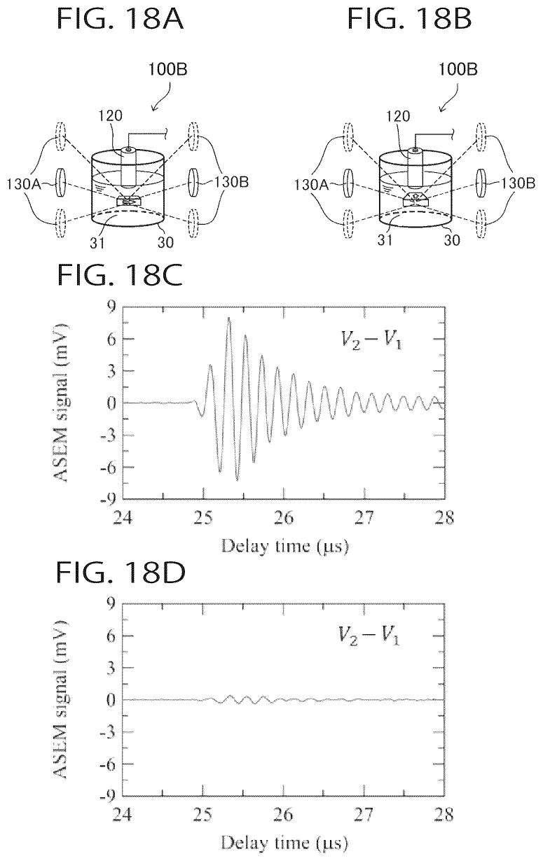

FIGS. 18A-18D show an example configuration of the measurement device 100B, which is another variant of the measurement device 100 of the first embodiment.

This variant is similar to the first embodiment, except that one detector, first detector, 130A is arranged on one side of the tank 30, and another detector, second detector, 130B is arranged on the other side of the tank 30, except that the other detector is arranged on the other side of the tank 30, which is similar to the first embodiment, therefore redundant explanations may be omitted.

In this variant, the fact that the signal intensity of the electromagnetic field, especially after differential processing, can vary significantly depending on the arrangement of the two detectors 130A, 130B with respect to the direction of polarization in the object 10 to be measured, will be described in detail by illustrating the actual measurement results.

First, in the example shown in FIG. 18A, one detector, first detector, 130A comprises a detector at a position perpendicular or substantially perpendicular to the direction of polarization parallel to the paper surface, white arrow in FIG. 18A, at the measured object 10 to be measured. As a result, the first detector 130A detects the signal, V₁, of the electromagnetic field from the object 10 to be measured. In the example shown in FIG. 18A, the other detector, second detector, 130B also comprises a detector at a position perpendicular or substantially perpendicular to the direction of polarization parallel to the paper surface at the object 10 to be measured, similar to the first detector 130A. As a result, the second detector 130B detects the signal, V₂, of the electromagnetic field from the object 10 to be measured.

According to the arrangement of the two detectors 130A, 130B shown in FIG. 18A, the two detectors 130A, 130B detect the signal of the electromagnetic field from the object 0 to be measured at a position perpendicular or substantially perpendicular to the direction of the polarization. Here, the signals of the electromagnetic fields detected by the two detectors 130A, 130B are almost the same in intensity and inverted or 180 degrees different in phase, so that the signal intensity obtained by the difference of those signals is approximately doubled, and the noise in the same phase is reduced. As a result, when the difference, V₂−V₁, of the signal intensity of the electromagnetic field detected by the two detectors 130A, 130B is calculated, the measurement result with a strong signal intensity of the electromagnetic field is obtained as shown in FIG. 18C.

On the other hand, in the example shown in FIG. 18B, one detector, first detector, 130A comprises a detector at a position parallel or substantially parallel to the direction of polarization perpendicular to the paper surface, white arrow in FIG. 18B, in the object 10 to be measured. As a result, the first detector 130A detects the signal, V₁, of the electromagnetic field from the object 10 to be measured. In the example shown in FIG. 18A, the other detector, second detector, 130B also comprises a detector at a position parallel or substantially parallel to the direction of the polarization perpendicular to the paper surface at the object to be measured 10. As a result, the second detector 130B detects the signal, V₂, of the electromagnetic field from the object 10 to be measured.

According to the arrangement of the two detectors 130A, 130B shown in FIG. 18B, the two detectors 130A, 130B detect the signal of the electromagnetic field from the object 0 to be measured at a position parallel or substantially parallel to the direction of the polarization. Here, the intensity and phase of the signals of the electromagnetic fields detected by the two detectors 130A, 130B are almost the same as each other. As a result, when the difference, V₂−V₁, of the signal intensity of the electromagnetic field detected by the two detectors 130A, 130B is calculated, the measurement result is obtained in which the signal intensity of the electromagnetic field is weak or hardly observed, as shown in FIG. 18D.

It is very interesting to note that not only the positions of the two detectors 130A and 130B shown by solid lines in FIGS. 18(a) and (b), but also the respective positions shown by dotted lines, show almost the same trend as the measurement results shown in FIGS. 18C and D. Thus, it is worth noting that the same results of the present variant can be obtained even at, for example, the uppermost position of the paper in FIG. 18A, i.e., a position higher than the sonic medium 1, typically the water surface, in the tank 30. This is because when measuring fiber structures such as bones in the human body, the electromagnetic field from the fiber tissue can be detected even when the two detectors 130A and 130B are positioned away from the sound wave medium 31, i.e., away from the human skin, which greatly enhances the feasibility of diagnosis of such fiber structures in the human body.

### Variant (6) of the First Embodiment

This variation is similar to the first embodiment, except that two detectors 130A and 130B are provided vertically below the chamber 30, therefore redundant explanations may be omitted.

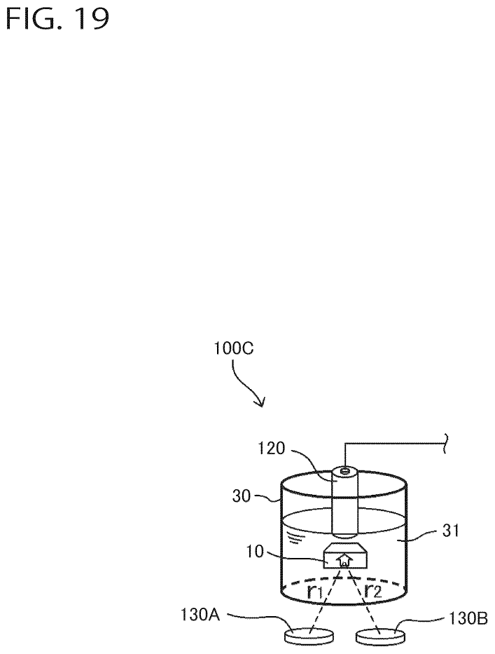

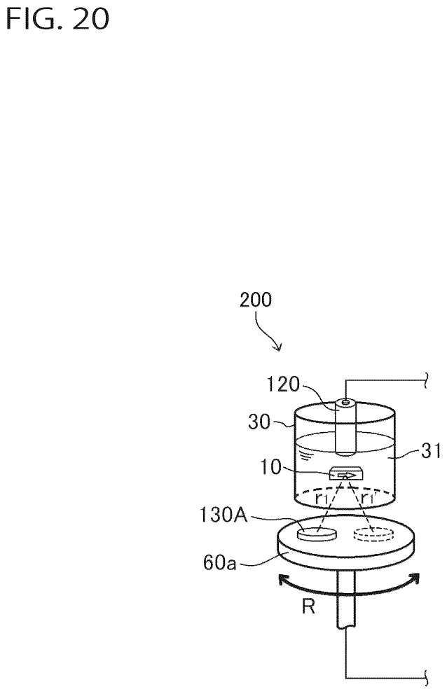

FIG. 19 shows an example configuration of the measurement device 100C of this variant for an object 10 to be measured, which is placed in a sound wave medium 31 in a tank 30. For example, the waveform generator 110 and the evaluator 152 are not depicted in FIG. 19 because FIG. 19 is a drawing illustrating in particular the relationship between the sound wave generator 120, the object 10 to be measured, the measurement object 10 and the two detectors 130A, 130B. FIGS. 20 through 23 are also depicted in the same manner as FIG. 19, with some configurations omitted.

As also explained in FIG. 5(d) or FIG. 5(e-1), if r₁ and r₂, the distance from the center of polarization to each of the detectors 130A, 130B, are equal, or substantially equal, the noise contained in the electromagnetic fields detected by the detectors 130A and 130B can be reduced or eliminated relatively easily by subtracting the electromagnetic field detected by the detector 130B from the electromagnetic field detected by the detector 130A, for example. Even if r₁ and r₂ are clearly different, the noise can be reduced or eliminated by the calculation.

### Variant (7) of the First Embodiment

This variation is similar to the first embodiment, except that one detector 130A is positioned vertically below the tank 30 and that the detector 130A can be rotated relative to the object 10 to be measured by the rotation mechanism 60A, therefore redundant explanations may be omitted.

FIG. 20 shows an example configuration of the measurement device 200 of this variant for the object 10 to be measured, which is placed in the sound wave medium 31 in the tank 30.

The measurement device 200 of this variation comprises a rotation mechanism 60a. The rotation mechanism 60a can be rotated in any of the rotational directions indicated by “R” in FIG. 20 by a known drive mechanism not shown in the Figure. In this variant, the detector 130A is fixedly arranged on the disk of the rotation mechanism 60a.

As a result, as described above, the detector 130A can be rotated relative to the object 10 to be measured by the rotation mechanism 60a.

In this variant, one detector 130A as a detector for detecting the electromagnetic field generated by the object 10 to be measured due to the sound waves emitted by the sound wave transmitter 120 can detect the electromagnetic field at at least two different positions relative to the object 10 to be measured by the rotation mechanism 60a. Therefore, it is worth noting that in this variant, one detector 130A plays the role of both a first detector in the detector and a second detector located at a different position from the first detector. As a result, in this variant, it is possible to evaluate the characteristics related to the anisotropy of the object 10 to be measured.

In this variant, for example, it is one of preferred aspects that the distance from the object 10 to be measured to the detector 130A, which plays the role of the detector, is substantially equidistant, i.e., substantially r₁=r₁′, when the rotation mechanism 60a rotates. By providing the aforementioned rotation mechanism 60a, it is possible to know both the position where the signal strength of the electromagnetic field is strongest and the position where signal strength is weakest.

In addition, since the measurement device 200 of this variant takes the difference of electromagnetic waves detected at different positions, at least one of the following configurations (1) and (2), not shown, can be provided to reduce or eliminate the noise in the electromagnetic field with higher accuracy and simplicity.

(1) A drive mechanism that automatically drives the rotating mechanism 60a to rotate at a time-constant angular velocity or at a time-dependent angular velocity. (2) a recording unit that records at least one position and measurement result selected from a group consisting of the position and measurement result with the strongest intensity and the position and measurement result with the weakest intensity among the intensities of signals of electromagnetic fields generated by the object 10 to be measured by sound waves emitted from the sound wave transmitter 120.

Additionally, the position of the strongest intensity in the signal of the electromagnetic field described above can be said to be in the direction along the polarization direction. Therefore, for example, it is extremely useful as information for knowing the direction of polarization in the object 10 to be measured, where the direction of polarization, typically the direction of orientation of the fiber structure, is unknown. Therefore, providing the rotation mechanism 60a is one of preferred aspects because it allows the direction of polarization of the subject 10 to be determined more easily and with higher accuracy.

From the viewpoint of reducing or eliminating the noise contained in the electromagnetic field with a higher degree of accuracy, the measurement method including the following processes (s1) to (s2) is a very preferred aspect.

(s1) the step of acquiring, by or without the rotation mechanism 60a, information on the position of the strongest intensity in the signal of the electromagnetic field described above.

(s2) the step of acquiring the detection result, measurement result, at or near the position where the intensity is strongest, and the detection result, measurement result, at or near the position when rotated 180 degrees from that position without substantially changing the distance from the object 10 to be measured, i.e., another position where the intensity is strongest.

By acquiring the detection results, measurement results, at the two positions in (s2) above, the two signals that are opposite in phase to each other and substantially the strongest in intensity are employed, thus making it possible to obtain the measurement result with the strongest intensity, that is, substantially the largest S/N ratio, at the object 10 to be measured.

Even if the rotation mechanism 60a is provided so that the distance from the object 10 to be measured to the detector 130A varies during rotation, i.e., r₁ and r₁′ differ, the noise in the electromagnetic field can be reduced or eliminated by a calculation that takes the distance into account.

Furthermore, by rotating the detector 130A by the rotation mechanism 60A described above, for example, the detector 130A continuously detects the signal of the electromagnetic field generated by the object 10 to be measured by the sound wave emitted from the sound wave transmitter 120. This is one of the other preferred aspects from the viewpoint of being able to acquire the time variation of the intensity of the signal. The acquisition of the time variation of the intensity of the signal by continuous detection of the signal by the detector 130A can be applied, for example, to the measurement of the object 10 to be measured where the measurement result cannot be predicted, for example, to the diagnosis of a fiber structure representative of biological fibrous tissue such as human bones, tendons, ligaments and the like.

Although this variant describes an example in which one detector 130A detects the electromagnetic field at two or more different positions relative to the object 10 to be measured by the rotation mechanism 60A, this variant is not limited to the aforementioned example. For example, even if the rotation mechanism 60A is not provided, manually detecting the electromagnetic field at different detection positions of the detector 130A is another possible aspect that one detector 130A can be employed to play the role of both the first detector and the second detector described above in the detector.

### Variant (8) of the First Embodiment

This variant is similar to the first embodiment and variant (7) of the first embodiment, except that the two detectors 130A, 130B are arranged vertically below the tank 30 and that the detectors 130A, 130B can be rotated relative to the object 10 to be measured by the rotation mechanism 60a. Therefore, redundant explanations may be omitted.

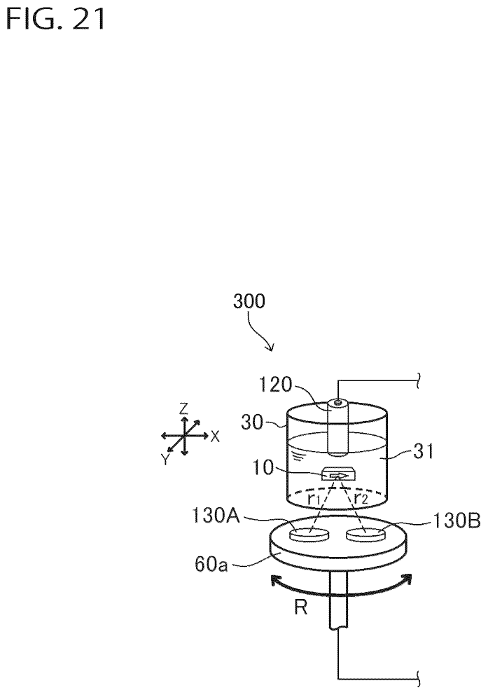

FIG. 21 shows an example configuration of the measurement device 300 of this variant for the object 10 to be measured, which is placed in the sound wave medium 31 in the tank 30.

The measurement device 300 of this variant comprises a rotation mechanism 60a as in the variant (7) of the first embodiment. Accordingly, the rotation mechanism 60a can be rotated in the rotational direction indicated by “R” in FIG. 21. The two detectors 130A, 130B are fixedly arranged on the disk of the rotation mechanism 60a.

As a result, as described above, the detectors 130A, 130B can be rotated relative to the object 10 to be measured by the rotation mechanism 60a.

In this variant, the two detectors 130A, 130B as detectors for detecting the electromagnetic field generated by the object 10 to be measured due to the sound wave emitted from the sound wave transmitter 120 can detect the electromagnetic field at at least two different positions relative to the object 10 to be measured by the rotation mechanism 60a.

In this variant, the positions of the two detectors 130A, 130B relative to the object 10 to be measured are not particularly limited. The area of the two detectors 130A, 130B, which play the role of detectors facing the object 10 to be measured, may be the same or substantially the same, including the meaning of “approximately the same,” which is also one of preferred aspects.

For example, as shown in FIG. 21, the other detector 130B may be arranged so that the position of one detector 130A when it is rotated 180 degrees by the rotation mechanism 60A coincides with the position of the other detector 130B, and so that the distances (r₁ and r₂ in FIG. 21) from the object 10 to be measured to the detectors 130A and 130B, respectively, are equal or substantially equal. By employing the aforementioned arrangement, if the two detectors 130A, 130B rotate 90 degrees, at least four positions of the electromagnetic field can be detected with respect to the object 10 to be measured, namely, the left and right positions in the horizontal direction (X direction in FIG. 21) and the front and rear positions in the depth direction (Y direction in FIG. 21), therefore this can contribute to shortening the rotation time, i.e., the measurement time of the electromagnetic field. In addition, due to the shortening of the rotation time, both the position where the signal strength of the electromagnetic field is strongest and the position where the strength is weakest can be known at an early stage. In addition, by taking the difference between the signals received at different positions, the noise in the electromagnetic field can be reduced or eliminated in a shorter time.

### Variant (9) of the First Embodiment

This variant is similar to the first embodiment and variant (7) of the first embodiment, except that one detector 130A is disposed vertically below the tank 30 and another detector 130B is disposed on the side of the tank 30, and that the detector 130A can be rotated relative to the object 10 to be measured by the rotation mechanism 60a and the detector 130B can be rotated relative to the object 10 to be measured by the rotation mechanism 60b. Therefore, redundant explanations may be omitted.

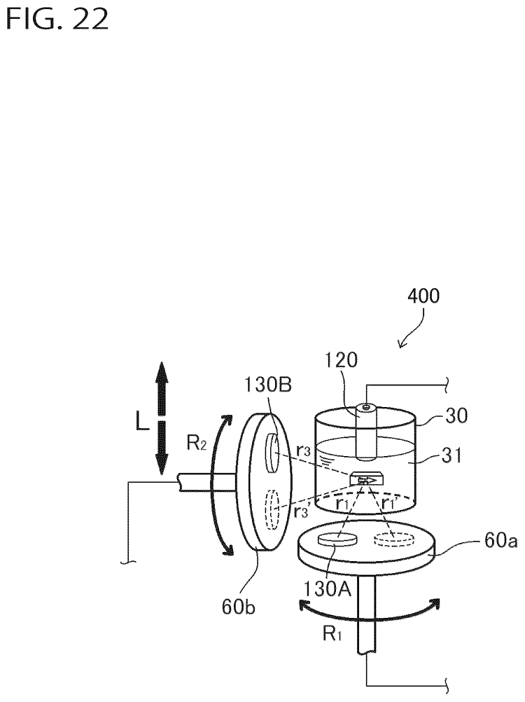

FIG. 22 shows an example configuration of the measurement device 400 of this variant for the object 10 to be measured, which is placed in the sonic medium 31 in the tank 30.

The measurement device 400 of this variation comprises a rotation mechanism 60a and a rotation mechanism 60b. Accordingly, the rotation mechanism 60a can rotate in any of the rotational directions indicated by “R₁” in FIG. 22, and the rotation mechanism 60b can rotate in any of the rotational directions indicated by “R₂” in FIG. 22 around an axis orthogonal to the axis of rotation of the rotation mechanism 60a. The detector 130A is fixed and arranged on the disk of the rotation mechanism 60a, and the detector 130B is fixed and arranged on the disk of the rotation mechanism 60b.

As a result, as described above, the detections 130A and 130B can be rotated relative to the object 10 to be measured by the rotation mechanisms 60a and 60b.

In this variant, the two detections 130A, 130B as detectors for detecting the electromagnetic field generated by the object 10 to be measured due to the sound waves emitted by the sound wave transmitter 120 are rotatable by the rotation mechanisms 60a, 60b so that each of the detections 130A, 130B can be rotated relative to the object 10 to be measured at different at least two positions, i.e., at least four positions for all of the detectors 130A, 130B.

In this variant, the position of the two detectors 130A, 130B relative to the object 10 to be measured is not particularly limited. Even if the detectors 130A and/or 130B are moved from the position shown in FIG. 22 below the tank 30 and/or the position shown in FIG. 22 on the side of the tank 30, for example in the direction L, up and down direction of the paper, at least some of the effects of this variant can be achieved.

As shown in FIG. 22, for example, the rotation mechanism 60a may be adjusted so that the distance from the object 10 to be measured to the detector 130A is substantially equidistant. i.e., substantially r₁=r₁′, during rotation, and the distance from the object 10 to be measured to the detector 130B is substantially equidistant, i.e., substantially r₃=r₃′, which is one of preferred aspects.

The aforementioned adjustment makes it possible to evaluate the electromagnetic field from the object 10 to be measured by the detector 130A, which detects the electromagnetic field in a direction that is substantially parallel to the direction of polarization, white arrow in FIG. 22, and the detector 130B, which detects the electromagnetic field in a direction that is substantially perpendicular to the direction of polarization. This is one of preferred aspects from the viewpoint of realizing evaluation of characteristics related to the anisotropy of the object 10 to be measured by detecting electromagnetic fields from a plurality of directions that differ from each other or at a plurality of positions that differ from each other. Each of the two detectors 130A, 130B makes it possible to know both the position where the signal intensity of the electromagnetic field is strongest and the position where the signal intensity of the electromagnetic field is weakest. Therefore, as an example, when the measurement device 400 of this variant comprises at least one of the configurations of (1) and (2) described in variant (7) of the first embodiment, at least one of the rotation mechanisms 60a and 60B can take the difference of the signals detected at different positions, so that the electromagnetic field can be reduced or eliminated more accurately and simply by providing at least one of the configurations (1) and (2) described in variation (7) of the first embodiment.

Although this variation example describes an example in which the two detectors 130A, 130B detect the electromagnetic field at two or more positions, i.e., at least four positions in all of the detectors 130A, 130B, that differ respectively relative to the object 10 to be measured by the rotation mechanisms 60a, 60b, this variation example is not limited to the aforementioned examples. For example, even if the rotation mechanisms 60a, 60b are not provided, manually detecting the electromagnetic field at different detection positions of the detector 130A is another possible aspect that one detector 130A can be employed to play the role of both the first and second detectors described above in the detector.

As a further variation of this variant, another aspect that can be employed is that the two detectors 130A, 130A are arranged on the rotation mechanism 60a and the two detectors 130B, 130B are arranged on the rotation mechanism 60b, as in variation (8) of the first embodiment. In addition, in a measurement device where the rotation mechanism 60a and the rotation mechanism 60b are not provided, the detector 130A of this variation may be placed at the position of the detector 130B of the variation (8) of the first embodiment, and one of the detectors 130B of this variation may be placed at the position that corresponds to the position when the other detector 130B is rotated 180 degrees by the rotation mechanism 60b, which is another aspect that can be employed.

### Variant (10) of the First Embodiment

This variant is similar to the first embodiment, except that one detector 130A is disposed only on the side of the tank 30 and that the detector 130A can be rotated along the circumference of the tank 30 with respect to the object 10 to be measured by a rotation mechanism not shown in the figure to change its relative position. Therefore, redundant explanations may be omitted.

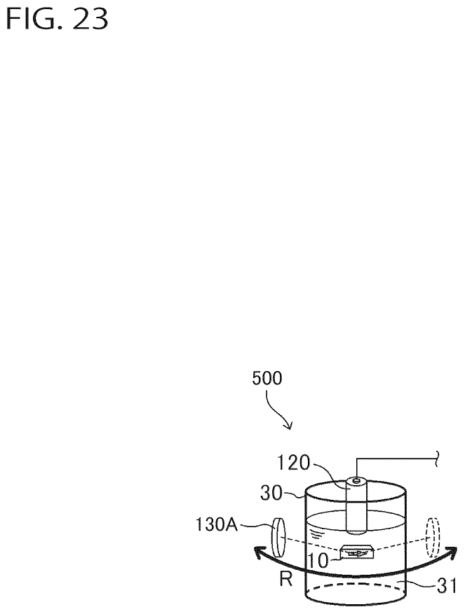

FIG. 23 shows an example configuration of the measurement device 500 of this variant for the object 10 to be measured, which is placed in the sound wave medium 31 in the tank 30.

In this variant of the measurement device 500, the rotation mechanism allows the detector 130A to rotate in any of the rotational directions indicated by “R” in FIG. 22 along the circumference of the tank 30.

As a result, the detection 130A can be rotated relative to the object 10 to be measured by the rotation mechanism.

In this variant, one detection 130A as a detector that detects the electromagnetic field generated by the object 10 to be measured due to the sound waves emitted by the sound wave transmitter 120 is able to detect the electromagnetic field at at least two different positions relative to object 10 to be measured by the rotation mechanism. Therefore, it is worth noting that in this variant, as in the variant (6) of the first embodiment, one detector 130A plays the role of both a first detector at the detection area and a second detector located at a different position from the first detector. As a result, even in this variant, it is possible to evaluate the characteristics related to the anisotropy of the object 10 to be measured.

Although this variation example describes an example in which one detector 130A detects the electromagnetic field at two or more different positions relative to the object 10 to be measured by the rotation mechanism, this variation example is not limited to the aforementioned examples. For example, even if the rotation mechanism is not provided, manually detecting the electromagnetic field at different detection positions of the detector 130A is another possible aspect so that one detector 130A can be employed to play the role of both the first and second detectors described above in the detector.

### Variant (11) of the First Embodiment

This variant is similar to the first embodiment and variant (2) of the first embodiment, except that, instead of the amplifiers/filters 140A and 140B in the measurement device 100 of the variant (2) of the first embodiment, a capacitor 190A, a coil 190B and a resistor 190C are connected to the wiring from one detector 130A to the differential amplifier 145, and to the wiring from another detector 130B to the differential amplifier 145, in parallel. Therefore, redundant explanations may be omitted.

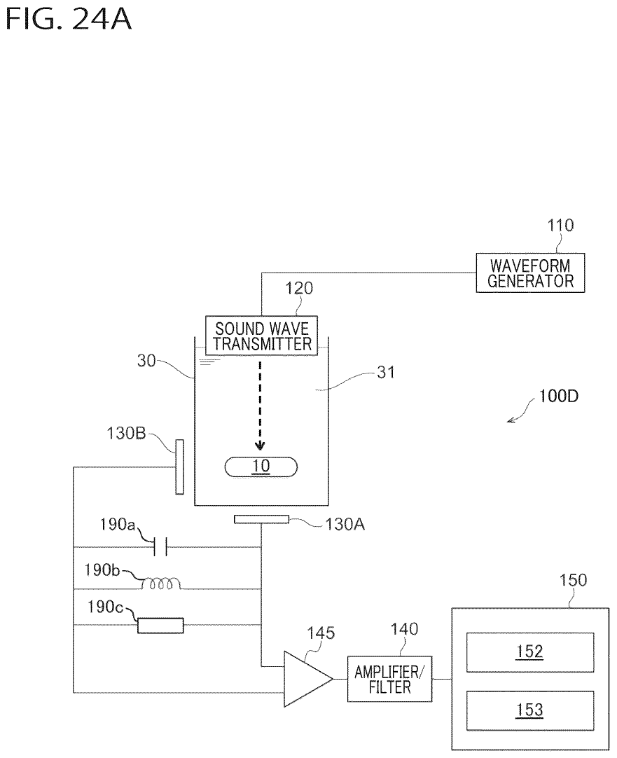

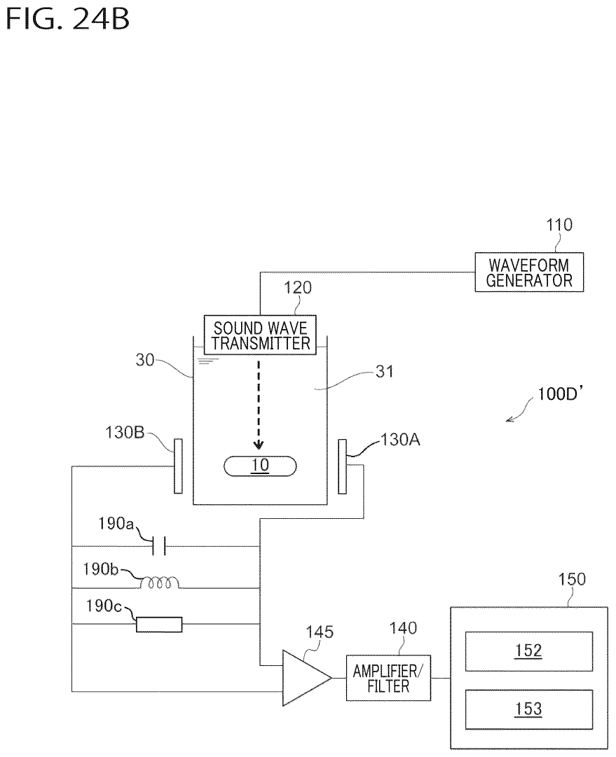

FIGS. 24A and B show an example configuration of the measurement device 100D of this variant for the object 10 to be measured, which is placed in a sonic medium 31 in a tank 30.

As shown in FIG. 24A or FIG. 24B, in this variant of the measurement device 100D, by providing a capacitor 190A, a coil 190B and a resistance 1900 from the two detectors 130A, 130B that detect the electromagnetic field generated by the object 10 to be measured to the differential amplifier 145, it is possible to form a resonance filter tuned to the frequency of the sound wave transmitted by the sound wave transmitter 120 so that the noise in the electromagnetic field, the signal of the electromagnetic field, can be reduced or eliminated. In addition, the differential amplifier 145 outputs a differential signal of the electromagnetic field after processing of the noise by the capacitor the 190a, the coil 190b and the resistor 190c, which can further reduce or eliminate noise in the electromagnetic field. Therefore, in this variant, the group comprising the capacitor 190a, the coil 190b and the resistor 190a, and/or the differential amplifier 145 plays the role of the noise processor 151 in the measurement device 100 of the first embodiment. It is not limited to the two detectors 130A, 130B shown by FIG. 24A or FIG. 24B, however, for example, arranging two detectors 130A, 130B below the paper surface of the tank 30 is another possible variant that can be employed.

Next, one further variation of this variant, the measurement device 100E, will be described.

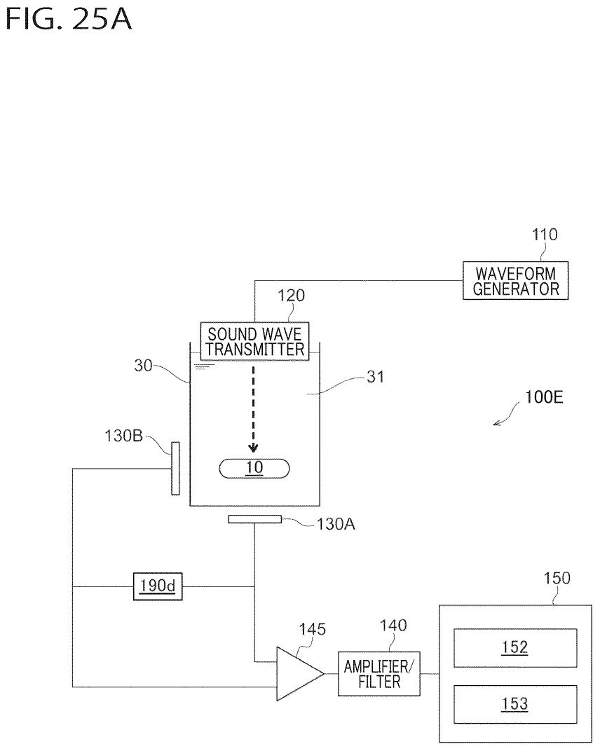

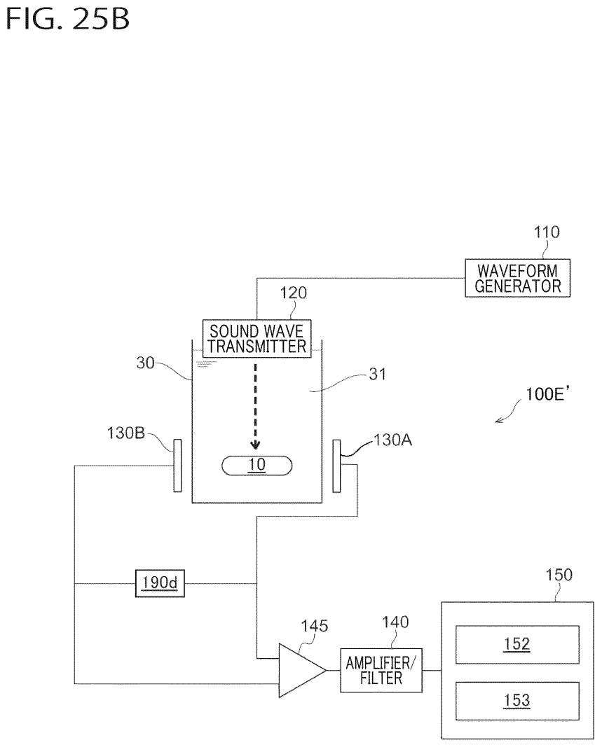

FIGS. 25A and B show an example configuration of the measurement device 100E, one of the further variations of this variant.

The variant shown in FIGS. 25A and B is similar to the first embodiment and variant (2) of the first embodiment, except that, instead of the amplifiers/filters 140A and 140B in the measurement device 100 of the variant (2) of the first embodiment, a resonant circuit 190d is connected to the wiring from one detector 130A to the differential amplifier 145, and to the wiring from another detector 130B to the differential amplifier 145, in parallel. Therefore, redundant explanations may be omitted.

As shown in FIG. 25A or FIG. 24B, in this variant of the measurement device 100E, by providing a resonant circuit 190D tuned to the frequency of the sound waves transmitted by the sound wave transmitter 120 from the two detectors 130A, 130B that detect the electromagnetic field generated by the object 10 to be measured to the differential amplifier 145, it is possible to reduce or eliminate extraneous noise outside of this frequency band and to improve the S/N ratio because the detection signal is accumulated in the resonance circuit. In addition, the differential amplifier 145 outputs a differential signal of the electromagnetic field after processing of the noise by the capacitor the 190a, the coil 190b and the resistor 190c, which can further reduce or eliminate noise in the electromagnetic field. Therefore, in this variant, the resonant circuit 190D and/or the differential amplifier 145 plays the role of the noise processor 151 in the measurement device 100 of the first embodiment. It is not limited to the two detectors 130A, 130B shown by FIG. 25A or FIG. 25B, however, for example, arranging two detectors 130A, 130B below the paper surface of the tank 30 is another possible variant that can be employed.

### Other Variations (1) of the First Embodiment

In this variation example, as another example of the fiber tissue of the first embodiment, an example in which the measurement device 100 and the measurement method of the first embodiment are applied to a bone, more specifically a bovine femur, as the object 10 to be measured will be described.

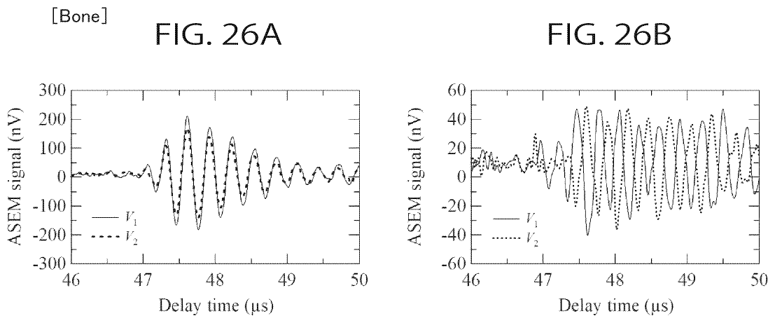

FIGS. 26A and B show a graph (a) of the results of measurement using the measuring device 100C in the case where the distance of r1 is equal to the distance of r2 in the variant (6) of the first embodiment and the polarization of the bovine femur is parallel to the direction of ultrasound irradiation, and (b) of the results of measurement using the measuring device 100C in the case where the polarization of the bovine femur is perpendicular to the direction of ultrasound irradiation. In this variant, the distance from the sound wave transmitter 120 to the object 10 to be measured is about 70 mm. The frequency of the sound wave transmitted by the sound wave transmitter 120 to the object 10 to be measured is 3.5 MHz. The distance from the object 10 to be measured to the two detectors 130A and 130B are both about 15 mm.

In one example of the measurement method using the measurement device 100C in this variant, it is assumed that the direction of the sound wave transmitted by the sound wave transmitter is substantially perpendicular to the direction of polarization of the object 10 to be measured. In this case, the measurement of this variant is performed under the conditions that the two detectors 130A, 130B are at equal, or substantially equal, distances from the object 10 to be measured and that the relative positions of the two detectors 130A, 130B with respect to the object 10 to be measured are not changed when the electromagnetic field from the object 10 to be measured is detected.

As a result, as shown in FIG. 26A, the first signal of the electromagnetic field detected by the detector 130A coincides, or substantially coincides, in phase with the second signal of the electromagnetic field detected by the detector 130B, and the intensity of the first signal, V₁ in FIG. 26A, is equal to, or substantially equal to, the intensity of the second signal, V₂ in FIG. 26A. Then, when the first and second signals are added, the intensity of the signal of the electromagnetic field becomes about twice as large, and when the intensities are subtracted, the intensity of the signal of the electromagnetic field almost disappears.

On the other hand, in an example of the measurement method using the measurement device 200 in this variant, it is assumed that the direction of the sound wave transmitted by the sound wave transmitter is substantially perpendicular to the polarization direction of the object 10 to be measured. In this case, the relative position of the detector 130A with respect to the object 10 to be measured is changed by the rotation of one detector 130A.

As a result, as shown in FIG. 26B, the phase of the first signal of the detector 130A is inverted or 180 degrees different from the phase of the second signal of the detector 130B. The intensity of the first signal, V₁ in FIG. 26A, and the intensity of the second signal. V₂ in FIG. 26A, are equal, or substantially equal. Then, when the first and second signals are added, the intensity of the signal of the electromagnetic field almost disappears, and when the intensities are subtracted, the intensity of the signal of the electromagnetic field becomes about twice as large.

As described above, by employing an example of the measurement method of this variant, even when a bone, more specifically a bovine femur, is used as the object 10 to be measured, it is possible to increase the intensity of the signal of the electromagnetic field from the object 10 to be measured and thus to acquire the signal of the electromagnetic field from the object 10 to be measured with a high degree of accuracy.

Other Variations (2) of the First Embodiment By the way, in each of the above embodiments, a fiber structure without a center of symmetry using the acoustic induced electromagnetic method was described. However, the application of the embodiment is not limited to fiber structures. For example, using a crystal that does not have a center of symmetry using the acoustic induced electromagnetic method, e.g., a crystal with a specified piezoelectric polarization, as the object 10 to be measured is another example that can be employed.

Example of Measurement when a Crystal is Used as the Object 10 to be Measured

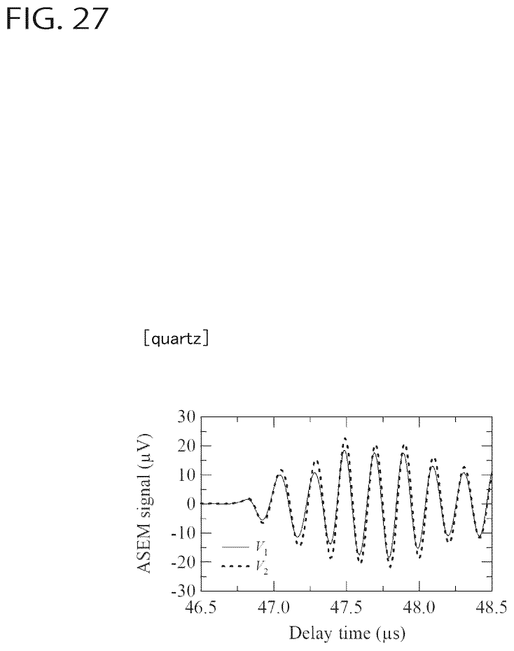

FIG. 27 is a graph of measurement results using the measurement device 100C of variant (6) of the first embodiment, when a crystal is used as the object 10 to be measured. In this variation example, the distance from the sound wave transmitter 120 to the object 10 to be measured is about 70 mm. The frequency of the sound wave transmitted by the sound wave transmitter 120 to the object 10 to be measured is 3.5 MHz. The distance from the object 10 to be measured to the two detectors 130A and 130B are both about 15 mm.

In one example of the measurement method using the measurement device 100C in this variant, it is assumed that the direction of the sound wave transmitted by the sound wave transmitter is parallel to the polarization direction of the object 10 to be measured. In this case, the measurement of this variation example is performed under the conditions that the two detectors 130A, 130B are at equal, or substantially equal, distances from the object 10 to be measured and that the relative positions of the two detectors 130A, 130B with respect to the object 10 to be measured are not changed when the electromagnetic field from the object 10 to be measured is detected.

As a result, as shown in FIG. 27, the first signal of the electromagnetic field detected by the detector 130A coincides, or substantially coincides, in phase with the second signal of the electromagnetic field detected by the detector 130B, and the intensity of the first signal, V₁ in FIG. 27, is equal, or substantially equal, to the intensity of the second signal, V₂ in FIG. 27. Then, when the intensity of the first signal, V₁ in FIG. 27, and the intensity of the second signal, V₂ in FIG. 27 are added, the intensity of the signal of the electromagnetic field becomes about twice as large, and when the intensities are subtracted, the intensity of the signal of the electromagnetic field almost disappears.

As described above, by employing an example of the measurement method of this variant, even when a crystal is used as the object 10 to be measured, it is possible to increase the intensity of the signal of the electromagnetic field from the object 10 to be measured so that the signal of the electromagnetic field from the object 10 to be measured can be obtained with a high degree of accuracy.

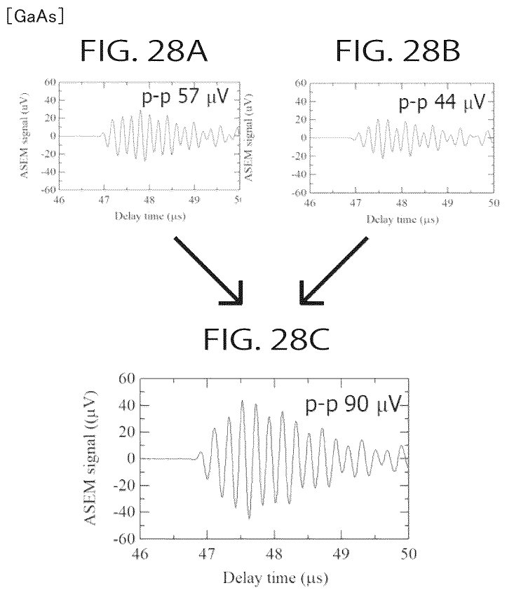

Measurement example (1) when a gallium arsenide (GaAs) substrate is used as the object 10 to be measured FIGS. 28A-C is a graph of the measurement results using the measurement device 200 of variant (7) of the first embodiment when a gallium arsenide (GaAs) substrate is used as the object 10 to be measured.

In this variant, the distance from the sound wave transmitter 120 to the object 10 to be measured is about 70 mm. The frequency of the sound waves transmitted by the sound wave transmitter 120 to the object 10 to be measured is 3.5 MHz. In addition, the distance from the object 10 to be measured to the detector 130A is about 15 mm.

In one example of the measurement method using the measurement device 200 of this variant, it is assumed that the direction of the sound wave transmitted by the sound wave transmitter 120 is substantially perpendicular to the polarization direction of the object 10 to be measured. In this case, one detector 130A is rotated, and the relative position of the detector 130A with respect to the object 10 to be measured is changed.

As a result, as shown in FIGS. 28A-C, for example, the phase of the first signal when one detector 130A detects an electromagnetic field from the object 10 to be measured at a certain position is inverted or 180 degrees different from the phase of the second signal when the detector 130A detects an electromagnetic field from the object 10 to be measured at a position rotated 180 degrees from the above position by the rotation mechanism 60a. On the other hand, the intensity of the first signal of the electromagnetic field detected by the detector 130A is different from the intensity of the second signal of the electromagnetic field detected by the detector 130B. This may be due to the fact that the position of the detector 130A before and after rotation is not perfectly perpendicular to the polarization direction of the object 10 to be measured, and/or the received signal includes not only components perpendicular to the polarization direction but also components parallel to it.

When the intensity of the first signal is differenced from the intensity of the second signal, the signal intensity of the electromagnetic field is greater than the intensity of the first and second signals, respectively, because they are inverted or 180 degrees different in phase from each other, as described above.

As described above, by employing an example of the measurement method of this variant, even when a gallium arsenide (GaAs) substrate is used as the object 10 to be measured, it is possible to increase the intensity of the signal of the electromagnetic field from the object 10 to be measured so that the signal of the electromagnetic field from the object 10 to be measured can be obtained with a high degree of accuracy.

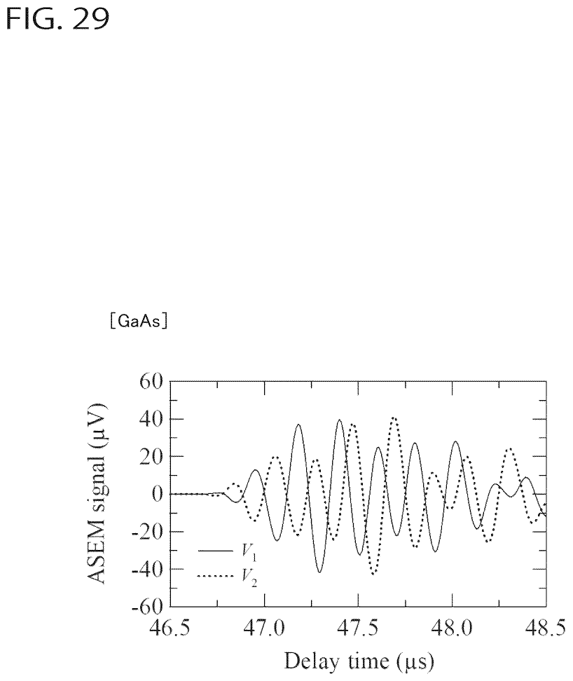

Measurement example (2) when a gallium arsenide (GaAs) substrate is used as the object 10 to be measured FIG. 29 is a graph of the measurement results using the measurement device 100C of variant (6) of the first embodiment, when a gallium arsenide (GaAs) substrate is used as the object 10 to be measured.

In this variant, the distance from the sound wave transmitter 120 to the object 10 to be measured is about 70 mm. The frequency of the sound wave transmitted by the sound wave transmitter 120 to the object 10 to be measured is 3.5 MHz. In addition, the distance from the object 10 to be measured to the two detectors 130A and 130B are both about 15 mm. FIG. 29 is a graph of the electromagnetic field detected by one detector 130A, and FIG. 29 is a graph of the electromagnetic field detected by the other detector 130B.

In one example of the measurement method using the measurement device 100C of this variant, it is assumed that the direction of the sound wave transmitted by the sound wave transmitter is substantially parallel to the polarization direction of the object 10 to be measured. In this case, the measurement of this variant is performed under the conditions that the two detectors 130A, 130B have equal, or substantially equal, distances from the object 10 to be measured and that the relative positions of the two detectors 130A, 130B with respect to the object 10 to be measured are not changed when the electromagnetic field from the object 10 to be measured is detected.

As a result, as shown in FIG. 29, the phase of the first signal of the detector 130A is inverted or 180 degrees different from the phase of the second signal of the other detector 130B. The intensity of the first signal and the intensity of the second signal will then be equal, or substantially equal. Then, when the first and second signals are added, the intensity of the signal of the electromagnetic field will almost disappear, and when they are subtracted, the intensity of the signal of the electromagnetic field will be about twice as large.

As described above, by employing an example of the measurement method of this variant, even when a gallium arsenide (GaAs) substrate is used as the object 10 to be measured, it is possible to increase the intensity of the signal of the electromagnetic field from the object 10 to be measured so that the signal of the electromagnetic field from the object 10 to be measured can be obtained with a high degree of accuracy.

### Second Embodiment

In this embodiment, an example is described in which two detectors 130A, 130B are integrated with the housing 230 of the sound wave medium 31 (e.g., a bottomless cylindrical body 230a made of resin comprising a membrane 170 through which sound waves can pass, such as a silicone rubber membrane, as a lid or bottom) by being bonded, supported or deposited on the outer periphery or outer surface of the housing 230. Therefore, except for the above-mentioned details, explanations duplicating the first embodiment and each variant of the first embodiment may be omitted.

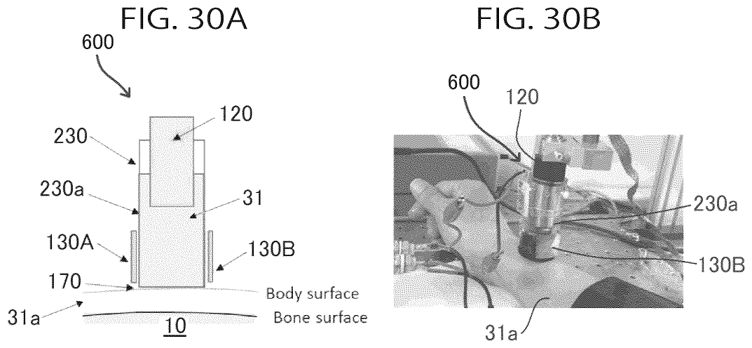

FIG. 30A shows an example configuration of the measurement device 600 of this embodiment in which the two detectors 130A, 130B and the housing 230 that houses the sound wave medium 31 are integrated. A typical example of the material of the two detectors 130A, 130B is copper. A typical example of the material of the bottomless cylindrical body 230A is acrylic resin.

FIG. 30B is an example of a photograph of a human arm bone being measured using the measurement device 600.

By employing the measurement device 600 of this embodiment, the two detectors 130A, 130B are integrated with the sound wave medium 31 and the housing 230. Therefore, typically, the size of the measurement device is reduced, the ease of handling the measurement device is improved, and the position of the detectors 130A, 130B is less subject to fluctuation, thereby the stability or reliability of the measurement results can be improved.

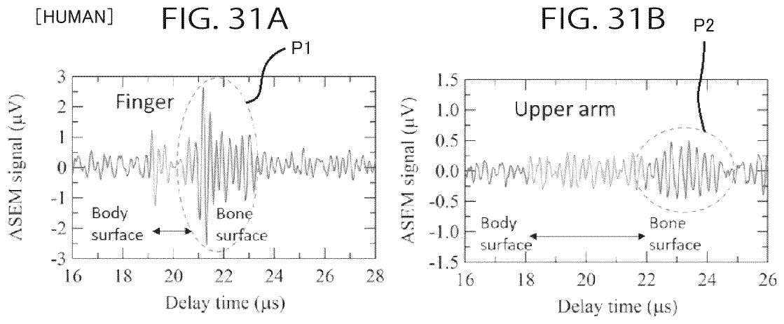

FIGS. 31A and B is a graph (a) of the measurement results using the measurement device 600 of the second embodiment when the bone of a human finger is the object 10 to be measured, and a graph (b) of the measurement results using the measurement device 600 of the second embodiment when the bone of a human upper arm is the object 10 to be measured. In the measurement example of this embodiment, the distance from the sound wave transmitter 120 to the object 10 to be measured is approximately 32 mm. The frequency of the sound wave transmitted by the sound wave transmitter 120 to the object 10 to be measured is 3.5 MHZ. The distance from the object 10 to be measured to the two detectors 130A and 130B are both about 20 mm.

As shown in FIGS. 31A and B, it was confirmed that the signal intensity of the electromagnetic field in the range indicated by the arrows in the figure, from the human skin, body surface, to the bone surface, and the signal intensity of the electromagnetic field generated by the bone, P1 and P2, can be easily and clearly distinguished by using the measurement device 600. Therefore, it can be said that the realization of measuring the polarization of bone in the human body will greatly enhance the feasibility of human bone diagnosis.

### OTHER EMBODIMENTS

In each of the above embodiments, it is another aspect that can be employed that various processors other than the CPU execute the measurement process and noise reduction or elimination process, which are executed by the CPU after reading the software, i.e., program. Examples of the aforementioned processors include a PLD (Programmable Logic Device), whose circuit configuration can be changed after manufacture, such as a FPGA (Field-Programmable Gate Array) and a dedicated electrical circuit, which is a processor with a circuit configuration designed specifically to cause it to perform a particular process, such as an ASIC (Application Specific Integrated Circuit). Another aspect that can be employed is to perform the measurement processing and noise reduction or elimination processing with one of these various processors, or with a combination of two or more processors of the same or different types, e.g., multiple FPGAs and combinations of CPUs and FPGAs. More specifically, the hardware structure of these various processors is an electric circuit that combines circuit elements such as semiconductor devices.

In each of the above embodiments, the above described manner in which the programs for the measurement process and the noise reduction or elimination process are pre-stored, i.e., installed, in ROM or storage is described, but it is not limited to this manner. For example, the programs may be provided by being installed in non-temporary (non-transitory) recording medium such as CD-ROM (Compact Disk Read Only Memory), DVD-ROM (Digital Versatile Disk Read Only Memory) and USB (Universal Serial Bus) memory, which is another aspect that can be employed. In addition, an embodiment in which the program is downloaded from an external device via a network can be employed as an example.

As mentioned above, the disclosure of each of the above embodiments is described for the purpose of explaining those embodiments and is not intended to limit the present invention. In addition, variations that exist within the scope of the invention, including other combinations of each embodiment, are also included within the scope of the claims.

The effects described in each of the above embodiments are illustrative or exemplary and are not limited to those described in the above embodiments. In other words, the technology of the present invention can produce, together with or instead of the effects described in each of the above embodiments, other effects that are obvious to a person having ordinary knowledge in the art of the invention from the description in each of the above embodiments.

### REFERENCE SIGNS LIST

10 Object to be measured,
30 Tank,
31, 31a Sound wave medium,
60a, 60b Rotation mechanism,
100, 100A, 100B, 100D, 100D′, 100E, 100E′, 200, 300, 400,
500, 600 Measurement device,
110 Waveform generator,
120 Sound wave transmitter,
130A, 130B Detector,
140, 140A, 140B Amplifier/filter,
145 Differential amplifier,
150 Signal processor,
151 Noise Processor,
152 Evaluator,
153 Image processor,
170 Membrane,
190a Capacitor,
190b Coil,
190c Resistor,
190d Resonant circuit,
230 Housing,
230a Bottomless cylindrical body.

1. A measurement device, comprising:
a sound wave transmitter transmitting sound waves to an object to be measured;
a detector detecting electromagnetic fields from multiple directions that differ from each other or at multiple locations that differ from each other, generated by the object to be measured due to the sound waves emitted from the sound wave transmitter; and
an evaluator evaluating anisotropic characteristics of the object to be measured based on the detection results of the electromagnetic fields detected by the detector.

2. The measurement device according to claim 1, further comprising a noise processor for reducing or eliminating noise contained in the electromagnetic fields by performing operations using the detection results of the electromagnetic fields from multiple directions that differ from each other or at multiple locations that differ from each other by the detector.

3. The measurement device according to claim 1, wherein the detector comprises a first detector detecting a first electromagnetic field and a second detector detecting a second electromagnetic field from a different direction or at a different location than the first detector, and
wherein the evaluator evaluates characteristics related to the anisotropy of the object to be measured based on the first detection result by the first detector and the second detection result by the second detector.

4. The measurement device according to claim 3, wherein the noise processor:
performs Fourier transformation on the first detection result by the first detector and the second detection result by the second detector;
obtains a coefficient by multiplying a waveform value normalized by each frequency component of the waveform after the Fourier transformation of the first detection result by the first detector by a complex conjugated value of the waveform value normalized by each frequency component of the waveform after the Fourier transformation of the second detection result by the second detector;
cuts off frequency components whose coefficients are less than a specific value from the first detection result by the first detector after Fourier the transformation and from the second detection result by the second detector after the Fourier transformation;
performs inverse Fourier transformation on the first detection result by the first detector after the Fourier transformation after the cut off and on the second detection result by the second detector after the Fourier transformation after the cut off; and
takes the difference between the first detection result by the first detector after the inverse Fourier transformation and the second detection result by the second detector after the inverse Fourier transformation.

5. The measurement device according to claim 3, wherein the second detector is arranged circumferentially, continuously or discontinuously outside of the first detector so as not to be tangential to the first detector.

6. The measurement device according to claim 1, further comprising an image processor imaging the detection results of the electromagnetic fields from multiple directions that differ from each other or at multiple locations that differ from each other by the detector,
wherein the sound wave transmitter scans the sound waves over a two-dimensional surface or a three-dimensional volume of the object to be measured.

7. The measurement device according to claim 1, wherein the evaluator evaluates the anisotropy of the fiber structure of the object to be measured based on at least one selected from the group of the difference or addition of the electromagnetic fields from multiple directions that differ from each other or at multiple locations that differ from each other by the detector and the ratio of the electromagnetic fields.

8. The measurement device according to claim 1, wherein the detector comprises a rotation mechanism rotating with respect to the object to be measured.

9. The measurement device according to claim 8, wherein the rotation mechanism is configured such that the distance from the object to be measured to the detector during rotation is substantially equidistant.

10. A measurement method, comprising:
a transmitting step for transmitting sound waves to an object to be measured;
a detection step for detecting electromagnetic fields from multiple directions that differ from each other or at multiple locations that differ from each other, generated by the object to be measured due to the sound waves emitted; and
an evaluation step for evaluating anisotropic characteristics of the object to be measured based on the detection results of the electromagnetic fields detected in the detection step.

11. The measurement method according to claim 10, further comprising a noise processing step for reducing or eliminating noise contained in the electromagnetic fields by performing operations on the detection results.

12. The measurement method according to claim 10, further comprising:
a detection step for detecting electromagnetic fields generated by the object to be measured due to being irradiated with sound waves at at least two positions or from at least two directions; and
an evaluation step for evaluating anisotropic characteristics of the object to be measured based on the relationship between the detection results of the electromagnetic fields at at least two positions or the electromagnetic fields from at least two directions detected in the detection step.
